(19) United States
(12) Patent Application Publication
(10) Pub. No.: US 2008/0274909 A1
(43) Pub. Date: Nov. 6, 2008

(54) Kits and Reagents for Use in Diagnosis and Prognosis of Genomic Disorders

(75) Inventor: Arthur R. Brothman, Salt Lake City, UT (US)

Correspondence Address: ROPES & GRAY LLP, PATENT DOCKETING 39/41, ONE INTERNATIONAL PLACE, BOSTON, MA, 02110-2624, US

(73) Assignee: The University of Utah, Salt Lake City, UT (US)

(21) Appl. No.: 11/587,116

(22) PCT Filed: Apr. 22, 2005
(86) PCT No.: PCT/US05/13922

§ 371 Date: Sep. 20, 2007

Related U.S. Application Data
(60) Provisional application No. 60/564,361, filed on Apr. 22, 2004.

(51) Int. Cl. C40B 30/04; C40B 40/08

(52) U.S. Cl. 506/9; 506/17

(57) ABSTRACT

The invention provides articles of manufacture which are arrays, reagents, kits, and methods for diagnosis and/or prognosis of diseases with genomic aberrations. The methods of the invention identify differences between DNA samples from normal and disease tissues that are ascertained using comparative genomic hybridization (CGH) with microarrays of genomic fragments covering the whole genome of an organism, or microarrays containing subsets of the genome that are identified by the methods herein, for example, the long arm of chromosome 2 associated with prostate cancer. The detected genomic aberrations, are correlated to specific clinical outcomes, such that specific patterns of genomic aberration—disease association are identified in the majority of samples. The invention also provides genomic DNA arrays encompassing regions, the aberration of which was correlated to specific disease outcomes, for diagnosis/prognosis of such diseases.

### BACKGROUND OF THE INVENTION

Many diseases, such as various cancers, disease associated with chromosomal imbalance (e.g. Patau syndrome, Down's syndrome, etc.), and certain immunological and neurological diseases are caused by genomic aberrations, including deletion, inversion, duplication, multiplication, chromosomal translocation and other rearrangements, and point mutation. These aberrations either directly cause the diseases, or predispose the individuals with such aberrations to the diseases. In addition, the presence of certain aberrations determines the outcome of certain disease conditions. Therefore, screening for the status of these aberrations may provide valuable information not only useful for diagnosis, but also invaluable for prognosis and proper clinical management, including greatly improved health care, elimination of a significant number of unnecessary surgeries or other treatments, and improved quality of life of cancer patients. Additionally, study of these aberrations may be useful in building disease-mutation correlations for drug discovery.

For example, prostate cancer is the most common form of cancer, other than skin cancer, among men in the United States, and it is second only to lung cancer as a cause of cancer-related death among men. The American Cancer Society estimates that in 2003, about 220,900 new cases of prostate cancer will be diagnosed and 28,900 men will die of the disease. The five year age-standardized survival is 41%.

Risk factors for prostate cancer include age, race, diet, environment, country of origin, and familial history. Carter et al. reported that there is an autosomal dominant inheritance of a rare high-risk allele which accounts for 9% of all prostate cancers (Carter et al., Proc. Natl. Acad. Sci. U.S.A. 89: 3367-71, 1992). Although the model of inheritance is not defined, there appears to be a clear genetic component for prostate cancer susceptibility. In the past 15-20 years, significant efforts have been made by numerous investigators in determining the underlying genetic mechanisms of prostate cancer. While a large amount of data has been reported, no reliable prognostic indications have been described.

To illustrate, various chromosomal abnormalities have been described in prostate cancer. Among the most common reported are trisomy and hyperdiploidy (Cui et al., Cancer Genet Cytogenet 107: 51, 1998), gains of 6p, 7q, 8q, 9q, 16q (van Dekken et al., Lab Invest. 83: 789, 2003; Steiner et al., Eur Urol. 41: 167, 2002; Verhagen et al., Int J Cancer 102: 142, 2002; Brothman AJMG 115: 150, 2002), deletions of 3q, 6q, 8p, 10q, 13q, 16q, 17p, 20q (van Dekken, supra; Matsuyama et al., Aktuel Urol. 34: 247, 2003; Matsuyama et al., Prostate 54: 103, 2003; Bergerheim et al., Genes Chromosomes Cancer 3: 215, 1991), and aneusomy of chromosomes 7 and 17 (Cui, supra). Many reports have claimed to have clinical statistical significance with these common changes. Van Dekken and colleagues reported that gain at 8q was independently associated with disease progression after considering tumor grade and stage, margin status, and preoperative PSA (van Dekken, supra). Loss of heterozygosities (LOHs) at 13q14 and 13q21 were reported to be more common in tumors associated with local symptoms (Dong et al., Prostate 49: 166, 2001). Loss at 16q in combination with loss at 8p22 has been associated with metastatic prostate cancer (Matsuyama et al., Aktuel Urol. 34: 247, 2003). Several groups have reported that the number of genetic abnormalities seen correlates with worse prognosis (Brothman, Cancer Res. 50(12): 3795-803, 1990). Although trends from these studies have certainly emerged, chromosomal findings have varied substantially from series to series, and clinical correlations are often insufficient. Therefore, the clinical relevance of these genomic changes is not fully understood.

The two most common tests used by physicians to detect prostate cancer are the digital rectal examination (DRE) and the prostate-specific antigen (PSA) test. For the DRE, which has been used for many years, the physician inserts a gloved finger into the rectum to feel for abnormalities. The prostate-specific antigen test is a blood test that measures the PSA enzyme. Since the inception prostatic specific antigen (PSA) screening in the United States, the incidence of prostate cancer diagnosis has increased and a trend toward lower grade and lower stage tumors has been observed (Stephenson, Urol Clin North Am 29:173, 2002; Stephenson and Stanford, World J Urol 15: 331, 1997).

Although there is good evidence that PSA screening can detect early-stage prostate cancer, evidence is mixed and inconclusive about whether early detection improves health outcomes, since these lower stage and grade tumors tend to be more indolent. It is known that PSA level usually does not correlate with whether a prostate cancer will be aggressive (life threatening and ultimately metastatic) or indolent (clinically irrelevant). Thus, decisions regarding life-altering surgery thus cannot be made with confidence in many cases, and concern has risen about the over-treatment of certain tumors, especially those lower stage and grade tumors (Brothman, Am. J. Med. Genet. 115: 150-6, 2002). In addition, prostate cancer screening is associated with important harms. These include the anxiety and follow-up testing occasioned by frequent false-positive results, as well as the complications that can result from treating prostate cancers that, left untreated, might not affect the patient's health. Since current evidence is insufficient to determine whether the potential benefits of prostate cancer screening outweigh its potential harms, there is no scientific consensus that such screening is beneficial. The Centers for Disease Control and Prevention (CDC) does not recommend routine screening for prostate cancer because there is no scientific consensus on whether screening and treatment of early stage prostate cancer reduces mortality.

On the other hand, the best available prognosis predictor is the use of the histological grading system for prostate tumors. The ability to stage and grade prostate cancer accurately is of vital importance for prognosis and the choice of suitable treatment options. Lower T stages and Grade scores are associated with a better prognosis. Unfortunately, the staging and grading modalities currently available do not, however, always provide an accurate evaluation. There is a tendency to under-grade biopsy samples compared to grading obtained at radical prostatectomy. The interpretation is further hampered by the lack of information relating to the natural history of this disease.

This type of problem is not unique to prostate cancer. Even in diseases where reasonably reliable diagnostic and/or prognostic methods are available, the cost of performing such tests might be greatly expensive to prevent wide-spread use in general population screening. Thus, there is a need to identify a simple, efficient, cost-effective, and reliable method for the diagnosis and/or prognosis of diseases associated with genomic defects, such as prostate cancer. Such diagnosis/prognosis methods will become new tools to discern which patients are truly at increased risk for aggressive disease and require definitive therapy, while granting peace of mind to the majority of patients with low grade diseases and sparing them from costly but unnecessary surgeries and other treatments.

### SUMMARY OF THE INVENTION

The invention is based in part on the discovery that specific genes or gene groups have genomic aberrations that can be statistically significantly correlated to the development of certain clinical phenotypes (diagnosis) and disease progression (prognosis). Detecting the presence of certain aberrations in these genes in a sample allows for the diagnosis and prognosis of the these disease conditions in the patient from which the sample is obtained. Method and reagents of identifying such disease-correlation genes are also provided.

Accordingly, in one aspect the invention relates to the detection of genomic aberrations in genes that are differentially mutated in disease versus normal tissue samples, or different stages of diseased samples, e.g., metastatic versus non-metastatic tumor samples.

In one embodiment, the diagnostic method comprises determining whether a subject has mutations in a specific gene or a set of genes, the mutations of which have been positively or negatively correlated with one or more clinical phenotypes. According to the method, cell/tissue samples (disease v. normal or control) are obtained from a subject and the mutations in selected genomic regions viewed as the chromosomes of the somatic cells of the diseased tissue sample obtained via biopsy for diagnosis or via surgical removal of the cancer are determined using, for example, CGH (comparative genomic hybridization).

The cell/tissue specimen is obtained from a site or anatomical location of interest, i.e., a site on or in a mammalian host, which site may or may not have a malignant condition. The specimen may be obtained, for example, by scraping or washing of tissue at the site. Depending on the nature of the tissue involved, or the location of the tissue as the case may be, one may also collect a body fluid, such as, for example, sputum, which body fluid has been in contact with, and may be said to have washed, the tissue at the site. The cell specimen may be obtained in accordance with the usual techniques of biopsy. In the detection of cervical carcinoma, for example, a scraping from the cervix would be taken. To determine the presence of malignancy in the lung, a sputum sample would provide an exfoliative cell specimen to be used in the present method. The method finds utility in the detection of a malignant condition in various cell specimens from the cervix, vagina, uterus, bronchus, prostate, gastrointestinal tract including oral pharynx, mouth, etc., and cell specimens taken from impressions of the surface of tumors or cysts, the cut surface of biopsy specimens, especially lymph nodes, and serous fluids.

Samples, especially samples in small amount (e.g. biopsy) or limited supply (e.g. archived tissue), may optionally have their genomic DNA amplified by one or more methods as known to a person of skill in the art, such as those described herein.

Further provided is a kit comprising one or more reagents and/or articles of manufacture for detecting the presence of genomic aberrations in a set of genomic regions in tissue/cell samples. In certain embodiments, the subject kits will include an array of probe nucleic acids (such as arrays of genomic DNA covering the region of interest), which are capable of detecting such genomic aberrations by hybridization with nucleic acid fragments from the patient sample.

Thus one aspect of the invention provides a method for utilizing identification of genomic aberrations as a predictive screening assay in diagnosis and/or prognosis of a disease, comprising: determining, using genomic microarray-based comparative genomic hybridization (GM-CGH) of a plurality of tissue samples from a plurality of patients, respectively, the presence of at least one genomic aberration for at least one tissue sample from at least one patient; and, identifying the at least one genomic aberration as having a correlation with a diagnostic and/or prognostic outcome.

In a related aspect, the invention provides a method of identifying genomic aberrations of predictive value in diagnosis and/or prognosis of a disease, comprising: determining a presence of at least one genomic aberration for each of a plurality of whole tissue samples from patients with the disease, using genomic microarray-based comparative genomic hybridization (GM-CGH); identifying a correlation between the at least one of said genomic aberration and a particular diagnostic and/or prognostic outcome, with a correlation efficiency (r) of greater than 0.7 or less than −0.7. In one embodiment, the correlation is identified in more than about 15%, 25%, 35%, 50%, 60%, 75%, 90%, or about 95% or more of the samples.

In one embodiment, the tissue sample has a high degree of complexity and/or rare cellular species.

In one embodiment, the tissue sample is not purified to separate a plurality of cell sub populations.

In one embodiment, the genomic DNA in the tissue sample is amplified prior to analysis by GM-CGH.

In one embodiment, the genomic DNA is amplified by a whole genome amplification selected from: whole genome PCR, Lone Linker PCR, Interspersed Repetitive Sequence PCR, Linker Adapter PCR, Priming Authorizing Random Mismatches-PCR, single cell comparative genomic hybridization (SCOMP), degenerate oligonucleotide-primed PCR (DOP-PCR), Sequence Independent PCR, Primer-extension pre-amplification (PEP), improved PEP (I-PEP), Tagged PCR (T-PCR), tagged random hexamer amplification (TRHA); or using rolling circle amplification (RCA), multiple displacement amplification (MDA), or multiple strand displacement amplification (MSDA).

In one embodiment, the GM-CGH is label-reversal (label-swapping) GM-CGH.

In one embodiment, the genomic aberration comprises one or more of: deletion, duplication or multiplication, chromosomal translocation or rearrangement, and a manifestation as trisomy, heterodiploidy, chromosomal gain, chromosomal deletion, and aneusomy.

In one embodiment, the disease is cancer, such as a solid tumor, which may be selected from a tumor of the lung, prostate, breast, ovary, esophagus, head and neck, brain, colorectal, gastric, skin, liver, kidney, pancreas, mouth, and tongue.

In one embodiment, the cancer is a leukemia or a lymphoma.

In one embodiment, the cancer is prostate cancer.

In one embodiment, the cancer is acute.

In one embodiment, the cancer is chronic.

In one embodiment, the disease is a chromosomal imbalance/aberration disease, such as Patau Syndrome, Edwards Syndrome, Down's Syndrome, Turner's Syndrome, Klinefelter Syndrome, William's Syndrome, Langer-Giedon Syndrome, Prader-Willi, Angelman's Syndrome, Rubenstein-Taybi and DiGeorge's Syndrome, Double Y syndrome, Trisomy X syndrome, Four X syndrome, Duchenne's/Becker syndrome, congenital adrenal hypoplasia, chronic granulomatus disease, steroid sulfatase deficiency, X-linked lymphproliferative disease, 1p-(somatic) neuroblastoma, monosomy trisomy, monosomy trisomy 2q associated growth retardation, developmental and mental delay, and minor physical abnormalities, non-Hodgkin's lymphoma, Acute non lymphocytic leukemia (ANLL), Cri du chat; Lejeune syndrome, myelodysplastic syndrome, clear-cell sarcoma, monosomy 7 syndrome of childhood; renal cortical adenomas; myelodysplastic syndrome, myelodysplastic syndrome; Warkany syndrome; chronic myelogenous leukemia, Alfi's syndrome, Rethore syndrome, complete trisomy 9 syndrome; mosaic trisomy 9 syndrome, ALL or ANLL, Aniridia; Wilms tumor, Jacobson Syndrome, myeloid lineages affected (ANLL, MDS), CLL, Juvenile granulosa cell tumor (JGCT), 13q-syndrome; Orbeli syndrome, retinoblastoma, myeloid disorders (MDS, ANLL, atypical CML), myeloid and lymphoid lineages affected (e.g., MDS, ANLL, ALL, CLL), papillary renal cell carcinomas (malignant), 17p syndrome in myeloid malignancies, Smith-Magenis, Miller-Dieker, renal cortical adenomas, Charcot-Marie Tooth Syndrome type 1; HNPP, 18p partial monosomy syndrome or Grouchy Lamy Thieffry syndrome, Grouchy Lamy Salmon Landry Syndrome, trisomy 20p syndrome, Alagille, MDS, ANLL, polycythemia vera, chronic neutrophilic leukemia, papillary renal cell carcinomas (malignant), velocardiofacial syndrome, conotruncal anomaly face syndrome, autosomal dominant Opitz G/BBB syndrome, Caylor cardiofacial syndrome, and complete trisomy 22 syndrome.

In one embodiment, the genomic aberration comprises a deletion located in the long arm of chromosome 2.

In one embodiment, the genomic aberration consists of at least one deletion selected from the group consisting of: 2q14-24, 2q31-32, 5q12.1-31, 8p22, 10q25, 13q14-21, 16q24 and Xq12-22.

In one embodiment, the genomic aberration comprises at least one deletion of 2q14-24, 2q31-32, 5q12.1-31, 8p22, 10q25, 13q14-21, 16q24, and Xq12-22.

In one embodiment, the disease is prostate cancer.

In one embodiment, at least two of the samples are obtained from different tissues.

In one embodiment, the sample is a freshly obtained tissue.

In one embodiment, the sample is a stored sample.

In one embodiment, the prognosis is survival over a fixed length of time after diagnosis, or responsiveness to a specific treatment.

In one embodiment, the specific treatment is at least one selected from: hormone therapy, surgical intervention, radiotherapy, and chemotherapy.

In one embodiment, the disease is prostate cancer, and wherein the DNA in the microarray comprises normal human chromosomal DNA corresponding to a plurality of genomic aberrations selected from the group of deletions consisting of: 2q14-24, 2q31-32, 5q12.1-31, 8p22, 10q25, 13q14-21, 13q14-21, 16q24, and Xq12-22.

In one embodiment, the GM-CGH is performed with a genomic microarray comprising probes corresponding to all or part of the chromosomal regions identified in FIG. 3 as Prominent Minimal Region of Interest (PMRI).

In one embodiment, the GM-CGH is performed with a genomic microarray comprising probes corresponding to 8p and 13q chromosomal regions of said PMRI.

In one embodiment, the genomic microarray has a resolution of about 0.3 mega-base (Mb), 0.5 Mb, 0.8 Mb, 1 Mb, 2 Mb, or about 3 Mb.

Another aspect of the invention provides a method for diagnosis and/or prognosis of a prostate cancer, comprising: determining, by genomic microarray-based comparative genomic hybridization (GM-CGH), in a prostate tissue sample from a patient, the presence of one or more genomic aberrations as shown in Table 2.

In one embodiment, the tissue sample is obtained without isolation of tumor cell sub populations.

In one embodiment, the method is performed with a genomic microarray comprising probes corresponding to all or part of the chromosomal regions identified in FIG. 3 as Prominent Minimal Region of Interest (PMRI).

In one embodiment, detection of a loss at 5q12.1-31 or 2q indicates a positive node status.

In one embodiment, detection of a loss at 5q12.1-31 or 2q indicates a positive diagnosis.

Another aspect of the invention provides a subset of genomic DNA fragments, each encompassing at least one of the genomic aberrations of diagnosis and/or prognosis value for a disease as identified according to any of the above claims.

In one embodiment, the genomic DNA fragments comprises the chromosomal regions identified in FIG. 3 as Prominent Minimal Region of Interest (PMRI).

In one embodiment, the average size of the subset of genomic DNA fragments is about 0.3 mega-base (Mb), 0.5 Mb, 0.8 Mb, 1 Mb, 2 Mb, or about 3 Mb.

Another aspect of the invention provides a library of nucleic acids for detecting the genomic aberrations listed in Table 2 or the Prominent Minimal Region of Interest (PMRI) in FIG. 3.

Another aspect of the invention provides a genomic microarray for detecting genomic aberrations by GM-CGH, comprising nucleic acids for detecting at least one aberration listed in Table 2 or the Prominent Minimal Region of Interest (PMRI) in FIG. 3.

Another aspect of the invention provides a genomic microarray for detecting prostate cancer by GM-CGH of a tissue sample, comprising nucleic acid probes for detecting at least one aberration of chromosomes corresponding to locations 5q12.1-31 or 2q.

In one embodiment, the genomic microarray comprises nucleic acids for detecting a plurality of aberrations listed in Table 2 or the Prominent Minimal Region of Interest (PMRI) in FIG. 3.

In one embodiment, the genomic microarray comprises nucleic acids for detecting at least 10 aberrations listed in Table 2 or the Prominent Minimal Region of Interest (PMRI) in FIG. 3.

In one embodiment, the PMRI comprises those marked with an upward triangle in FIG. 3. In another embodiment, the PMRI consists of those marked with an upward triangle in FIG. 3. In yet another embodiment, the PMRI consists essentially of those marked with an upward triangle in FIG. 3.

In one embodiment, the average size of the nucleic acids in the genomic microarray is about 0.3 mega-base (Mb), 0.5 Mb, 0.8 Mb, 1 Mb, 2 Mb, or about 3 Mb.

Another aspect of the invention provides a medium embodying a database of disease tissues with a plurality of entries, comprising data selected from: two or more of each of tissue source, tissue type, patient information, GM-CGH-identified genomic aberration(s) in said disease tissues, associated with at least one of specific clinical outcome(s), and cytological corroboration data of said genomic aberration.

In one embodiment, the medium may be any computer-readable medium, such as floppy disk, hard drive, all variations of CDs, DVDs, ROMs, and RAMs, memory stick, USB keys, flash memory, tape, etc.

In one embodiment, the medium is analog or digital medium.

In one embodiment, the data are stored on a magnetic and/or an optical medium.

In one embodiment, the data are stored on a holographic data storage (HDS) device.

The database may also be stored in a medium according to U.S. Pat. Nos. 5,412,780 and 5,034,914.

In one embodiment, the disease tissues are prostate tissues.

In one embodiment, the genomic aberration(s) is a deletion of the long arm of chromosome 2.

In one embodiment, the specific clinical outcome(s) further comprises data from at least one of: surveillance of patients in remission; treatment monitoring for desired effect; treatment selection with respect to efficacy and safety; prognosis and staging of the tumor; differential diagnosis of metastasis; screening of tissues remote to site of initial tumor; and risk assessment for future cancer development.

Another aspect of the invention provides a medium comprising a computer program for selecting and analyzing data from a genomic microarray-based comparative genomic hybridization (GM-CGH) of a genome or a subset of a genome, wherein selecting the data comprises analyzing chromosomal loci corresponding to a specific disease.

In one embodiment, the disease is cancer.

In one embodiment, the disease is prostate cancer.

In one embodiment, selecting data comprises identifying/collecting hybridization to probes corresponding to chromosomal regions selected from at least one of: 2q14-24, 2q31-32, 5q12.1-31, 8p22, 10q25, 13q14-21, 16q24, and Xq12-22.

In one embodiment, selecting data comprises identifying/collecting hybridization to probes corresponding to chromosomal regions selected from at least one of: 2q14-24, 2q31-32, and 8p22.

Another aspect of the invention is a method of genomic microarray-based comparative genomic hybridization (GM-CGH) of a genome, the improvement comprising selecting data corresponding to one or more loci associated with a specific disease using a computer program, and diagnosing or prognosing the disease.

Unless otherwise defined, all technical and scientific terms used herein have the same meaning as commonly understood by one of ordinary skill in the art to which this invention pertains. Although methods and materials similar or equivalent to those described herein can be used in the practice or testing of the present invention, a few selected suitable methods and materials are described in more details below. All publications, patent applications, patents, and other references mentioned herein are incorporated by reference in their entirety. In case of conflict, the present specification, including definitions, will control. In addition, the materials, methods, and examples are illustrative only and are not intended to be limiting in any respect.

All embodiments of the invention, including those described under different aspects of the invention, are contemplated to be combined with other embodiments whenever applicable.

Other features and advantages of the invention will be apparent from the following detailed description and from the claims.

### BRIEF DESCRIPTION OF THE DRAWINGS

FIG. 1. Representative examples of genomic microarray data for four chromosomes from one prostate cancer patient, UCAP 24. Examples shown are for chromosomes 2, 6, 7 and 8. Upper plots are actual ratio plots generated from the SpectralWare® program (Spectral Genomics, Inc.) and lower plots are the scatter plots showing significant changes. Plots are positioned with distal short arms of the chromosomes at the left and distal long arms at the right of each ordinate axis. For ratio plots, divergence of a concurrent red line above and blue line below 1.0 signifies loss at that site, while a concurrent blue line above and red line below 1.0 signifies gain. For the lower scatter plot for each chromosome, statistically significant loss or gain is represented by red or blue dots, respectively, at each clone; no significant change is shown as a yellow dot.

FIG. 2. Summary ideogram of genomic microarray changes observed. Lines to the left of each chromosome represent loss at the indicated sites; lines to the right represent gains at those sites. Each line represents an individual change on a specific patient, corresponding to the data presented in Table 1.

FIG. 3 Master ideogram for prostate cancer abnormalities.

### DETAILED DESCRIPTION OF THE INVENTION

### 1. Overview

A confounding problem in genetic disease (especially cancer) diagnosis/prognosis has been the large amount of cellular heterogeneity in disease tissues. This is especially a problem for cancer tissues, partly due to their known tendency of chromosomal instability, and in some cases, different clonal origin and/or diverged progression from single clonal mutational events. Due to the nature of such disease tissues, there are no reliable methods to select only for tumor cell outgrowth for cytogenetic studies. This in turn has led to a high frequency of normal karyotypic findings for diseased tissues (false negative).

“Genetic heterogeneity,” which can be detected by conventional G-banding chromosome analysis, depends on the frequency of an aberrant clone and the number of cells analyzed, where the chromosomes of individual cells are analyzed. However, unlike the conventional cytogenetic approach of karyotype analysis, it is not the chromosomes of individual cells from a sample that are analyzed in microarray genome profiling, but rather the DNA sequence copy number of the total genomic DNA extracted from the cells of the sample. Consequently, from a DNA copy number perspective, the genome profile of a tumor maybe no different from that of total genomic DNA extracted from a reference population of 46, XX cells. Hence, the prior art has predicted that the genetic heterogeneity of this tumor sample would not be detected by microarray genome profiling.

The present invention is based at least in part that the detection of genetic heterogeneity in clinical samples, such that detection can be carried out under conditions and analysis to detect cell populations whose combined genetic profiles would have been predicted, e.g., by the prior art, to mask the presence of a heterogeneous population. In particular, the profiling methods of the present invention demonstrate the sensitivity with which it can detect clonally distinct cell populations within a more dominant background cell population.

As one way of overcoming this problem, specimens where a large abnormal clone was detected cytogenetically can be preferentially used over those with less prevalent clones. An alternative approach is to isolate tumor cells from normal cells by dissection, before DNA extraction and CGH analysis. For example, laser capture microdissection, a technique whereby a selected subset of cells are microscopically dissected, can be used to isolate tumor cells(Cai et al., Nat Biotechnol 20: 393-6, 2002; Verhagen et al., Cancer Genet Cytogenet 122: 43-8, 2000; Brothman and Cui, Methods Enzymol 356: 343-51, 2002). Although somewhat labor intensive, this is the technology that is most likely to eliminate the concern regarding detection of genetic heterogeneity.

Comparative genomic hybridization (CGH) is a well-established technique for surveying the entire genome for abnormalities (Kallionemi, 1992). However, standard CGH has relatively low resolution and has been used primarily on cell lines and in homogenous populations (sources). Since a nucleic acid array can be constructed from a large number of DNA fragments for example Bacterial Artificial Chromosome (BAC) clones a Genomic Microarray (GM) can be produced as an article of manufacture that provides a much higher-resolution analysis of chromosomal DNA gains/losses, and has recently shown promise in the analysis of fixed prostate tumors following tissue dissection. But its potential for studying solid tumor specimens is tempered by concerns about the inherent heterogeneity of a such a specimen that are addressed in the claims of this patent

One aspect of the invention provides a method to identify genomic aberrations as diagnosis/prognosis markers for certain diseases of interest. Briefly, genomic regions consistently mutated in various disease samples are identified using DNA hybridization with a genomic microarray-comparative genomic hybridization (GM-CGH). Statistical correlation between a subset of the identified genomic aberrations with certain clinically useful data, such as disease onset, progression, and likely clinical outcome are then established. Once identified, the specific subset of genomic aberrations serve as useful markers for reliable and cost-effective diagnosis and/or prognosis means for the disease of interest. These identified disease markers may be provided as specifically designed genomic microarrays in a diagnostic/prognostic test kit, optionally with instructions for using such genomic microarrays (including assay protocols and conditions), and/or control samples and result interpretation.

The instant invention provides in certain embodiments a sensitive method for analysis of genomic aberrations frequently observed in tumor tissues. Due to its unparalleled sensitivity, methods of the instant invention can detect genomic aberrations present in only a small portion of the disease tissue. Thus the methods of the instant invention can be used for analysis of genomic aberrations using whole disease tissues, which may include a significant portion of normal tissues. The methods of the instant invention can also be used for analysis of genomic aberrations in tissues exhibiting mosaicism or heterogeneity—having both normal and disease tissues, or tissues with different genomic aberrations.

In one embodiment, the disease tissue comprises at least about 10%, about 15%, about 20%, about 30% or more of the whole tissue used. The method can certainly be used for samples where disease tissue constitutes at least about 50%, about 60%, about 70%, about 80%, about 90%, about 95% or about 100% of the whole tissue used.

Part of the increased sensitivity results from the use of the dye-reverse hybridization technique, in which the labels (such as fluorescent dyes) used to label disease DNA probe and normal DNA probe (reference cell DNA) are swapped, i.e., mixtures that are oppositely labeled with respect to the dye, in two separate preparations. By doing so, the difference between normal and the disease genomic DNA is amplified by a factor of at least 2. Additional benefits of dye-reversal may include elimination of dye induced labeling bias.

The method of the subject invention can be used for analysis in any species, preferably in a mammal. For example, the mammal can be a human, nonhuman primate, mouse, rat, dog, cat, horse, or cow.

In some embodiments, the reference cell population is derived from a plurality of normal subjects. The reference cell population can be a database of expression patterns from previously tested cells for which one of the assayed parameters or conditions is known.

Once the genomic aberration is detected, the results can be used to determine if the aberration is correlated in any way to a host of useful clinical parameters, such as disease progression, patient prognosis outlook, response to certain treatment methods, etc. Such correlation will provide a reliable way to diagnose disease in an early stage by screening the general population, or at least the high-risk population. It can also help treatment management, such that only patients likely to respond to certain treatments are put through the treatment.

This general approach is particularly useful, since numerous disease conditions are associated with genomic aberrations, including deletion, and amplification, etc. Substantial efforts have been made trying to identify genomic regions consistently mutated in certain diseases, with the hope to identify mutations that can predict the onset, progression, and outcome of the disease involved. Unfortunately, in many diseases, especially cancer, genomic instability is a hallmark of these diseases. Many mutations are in fact the results, rather than the causes of the diseases. In addition, as mentioned above, in many solid tumors and other tumorigenically altered cell populations, genetic heterogeneity usually results from a progressive clonal differentiation of cells as the disease progresses. The resulting heterogeneity, observed in a single tumor sample from a single patient, can usually be far more complex than that observed in non-cancer samples. These complications make it quite difficult to identify the few aberrations that are truly associated with, and responsible for key aspects of the diseases, since these mutations are frequently masked by other less relevant secondary mutations.

Another complication relates to the fact that many disease conditions are associated with not a single, but multiple genetic aberrations. If one tries to establish a correlation between a single mutation with a certain disease phenotype, such as cancer prognosis, one frequently fails to identify a strong correlation, simply because the correlation really exists when two or more simultaneous mutations occur.

### II. Definitions

As used herein, the term “heterogeneity” refers to the occurrence in a sample of two or more cell populations of different chromosomal constitutions. These are acquired changes, having occurred after formation at the zygote stage of the (constitutional) genome of the individual. This is due to the clonal nature of many cancers, whereby a single cell is mutated by some event, and this cell gives rise to a clonal abnormal population of cells; this is a hallmark of most malignancies.

The heterogeneity observed in many solid tumors and other tumorigenically altered cell populations usually results from a progressive clonal differentiation of cells. The resulting heterogeneity can usually be far more complex than that observed in non-cancer samples.

The term “a high degree of complexity”, with respect to mosacism, refers to a sample of cells having 3 or more different chromosomal constitutions. In certain preferred embodiments, the subject method can be used to detect particular chromosomal abnormalities in cell samples having more than 5, 10 or even 20 different chromosomal constitutions.

The term “rare cellular species”, with respect to mosacism, refers to a cell of particular chromosomal constitution that represents less than 20 percent of an overall cell population. In certain preferred embodiments, the subject method can be used to detect particular chromosomal abnormalities in heterogeneous cell samples in which cells having the particular chromosomal abnormality are present at less than 10 percent of the overall cell population, or even less than 5, 1 or even 0.5 percent.

A “biological sample” or “sample” refers to a sample of tissue or fluid suspected of containing an analyte polynucleotide from an individual including, but not limited to, e.g., whole blood, plasma, serum, spinal fluid, lymph fluid, the external sections of the skin, respiratory, intestinal, and genitourinary tracts, tears, saliva, blood cells, tumors, organs, tissue and samples of in vitro cell culture constituents.

In certain cases, the probe or probe set of the invention can be provided free in a solution or immobilized on a solid support. For instance, the probe set can be divided up and individual members presented in microtiter wells or used as probes in Fluorescence In-Situ Hybridization (FISH) In other embodiments, the probe or probe sets can be spatially arrayed on a glass or other chip format.

The term “label-reversal (label-swapping) GM-CGH” refers to the reversal or swapping of labels used to label normal (control) DNA probe and sample (disease) DNA, in simultaneous or consecutive experiments. Results obtained from both sets of experiments can be combined to reveal small, yet still statistically significant changes that would be otherwise undetectable without label-reversal, partly due to the increased sensitivity of the experiments conferred by label-reversal. If the label is a fluorescent dye, it may also be called “dye-reversal (dye-swapping) GM-CGH.”

The term “hybridization”, as used herein, refers to any process by which a strand of nucleic acid binds with a complementary strand through base pairing.

“Microarray” refers to an array of distinct polynucleotides or oligonucleotides synthesized on a substrate, such as paper, nylon or other type of membrane, filter, chip, glass slide, or any other suitable solid support.

The terms “complementary” or “complementarity”, as used herein, refer to the natural binding of polynucleotides under permissive salt and temperature conditions by base-pairing. For example, the sequence “A-G-T” binds to the complementary sequence “T-C-A”. Complementarity between two single-stranded molecules may be “partial”, in which only some nucleotides or portions of the nucleotide sequences of the nucleic acids bind, or it may be complete when total complementarity exists between the single stranded molecules. The degree of complementarity between nucleic acid strands has significant effects on the efficiency and strength of hybridization between nucleic acid strands.

As used herein, the term “nucleic acid” refers to polynucleotides such as deoxyribonucleic acid (DNA), and, where appropriate, ribonucleic acid (RNA). The term should also be understood to include, as equivalents, analogs of either RNA or DNA made from nucleotide analogs, and, as applicable to the embodiment being described, single-stranded (such as sense or antisense) and double-stranded polynucleotides.

The terms “protein”, “polypeptide” and “peptide” are used interchangeably herein.

The term “substantially homologous”, when used in connection with amino acid sequences, refers to sequences which are substantially identical to or similar in sequence, giving rise to a homology in conformation and thus to similar biological activity. The term is not intended to imply a common evolution of the sequences.

The term “percent identical” refers to sequence identity between two amino acid sequences or between two nucleotide sequences. Identity can each be determined by comparing a position in each sequence which may be aligned for purposes of comparison. When an equivalent position in the compared sequences is occupied by the same base or amino acid, then the molecules are identical at that position; when the equivalent site occupied by the same or a similar amino acid residue (e.g., similar in steric and/or electronic nature), then the molecules can be referred to as homologous (similar) at that position. Expression as a percentage of homology/similarity or identity refers to a function of the number of identical or similar amino acids at positions shared by the compared sequences. Various alignment algorithms and/or programs may be used, including FASTA, BLAST or ENTREZ. FASTA and BLAST are available as a part of the GCG sequence analysis package (University of Wisconsin, Madison, Wis.), and can be used with, e.g., default settings. ENTREZ is available through the National Center for Biotechnology Information, National Library of Medicine, National Institutes of Health, Bethesda, Md. In one embodiment, the percent identity of two sequences can be determined by the GCG program with a gap weight of 1, e.g., each gap is weighted as if it were a nucleotide mismatch between the two sequences.

As used herein, “phenotype” refers to the entire physical, biochemical, and physiological makeup of a cell, e.g., having any one trait or any group of traits.

A disease, disorder, or condition “associated with” or “characterized by” an aberrant mutation in certain genes or genomic regions refers to a disease, disorder, or condition in a subject which is caused by, contributed to by, or causative of an aberration in a nucleic acid (e.g., genomic DNA).

The “growth state” of a cell refers to the rate of proliferation of the cell and the state of differentiation of the cell.

As used herein, “proliferating” and “proliferation” refer to cells undergoing mitosis.

As used herein, “transformed cells” refers to cells which have spontaneously converted to a state of unrestrained growth, i.e., they have acquired the ability to grow through an indefinite number of divisions in culture. Transformed cells may be characterized by such terms as neoplastic, anaplastic and/or hyperplastic, with respect to their loss of growth control.

As used herein, “immortalized cells” refers to cells which have been altered via chemical and/or recombinant means such that the cells have the ability to grow through an indefinite number of divisions in culture.

A “patient” or “subject” to be diagnosed, prognosed, staged, screened, assessed for risk, subject for selection of a treatment, and/or treated by the subject methods and articles of manufacture can mean either a human or non-human animal.

The term “carcinoma” refers to a malignant new growth made up of epithelial cells tending to infiltrate surrounding tissues and to give rise to metastases. Exemplary carcinomas include: “adenocarcinoma”, which is a tumor commonly found in the prostate that forms a gland with secretory ducts and is known to be capable of wide metastasis; “basal cell carcinoma”, which is an epithelial tumor of the skin that, while seldom metastasizing, has potentialities for local invasion and destruction; “squamous cell carcinoma”, which refers to carcinomas arising from squamous epithelium and having cuboid cells; “carcinosarcoma”, which include malignant tumors composed of carcinomatous and sarcomatous tissues; “adenocystic carcinoma”, carcinoma marked by cylinders or bands of hyaline or mucinous stroma separated or surrounded by nests or cords of small epithelial cells, occurring in the mammary and salivary glands, and mucous glands of the respiratory tract; “epidermoid carcinoma”, which refers to cancerous cells which tend to differentiate in the same way as those of the epidermis; i.e., they tend to form prickle cells and undergo cornification; “nasopharyngeal carcinoma”, which refers to a malignant tumor arising in the epithelial lining of the space behind the nose; and “renal cell carcinoma”, which pertains to carcinoma of the renal parenchyma composed of tubular cells in varying arrangements. Another carcinomatous epithelial growth is “papillomas”, which refers to benign tumors derived from epithelium and having a papillomavirus as a causative agent; and “epidermoidomas”, which refers to a cerebral or meningeal tumor formed by inclusion of ectodermal elements at the time of closure of the neural groove.

“Amplification of polynucleotides” utilizes methods such as the polymerase chain reaction (PCR), ligation amplification (or ligase chain reaction, LCR) and amplification methods based on the use of Q-beta replicase. These methods are well known and widely practiced in the art. Reagents and hardware for conducting PCR are commercially available. Primers useful to amplify specific sequences from selected genomic regions are preferably complementary to, and hybridize specifically to sequences flanking the target genomic regions.

“Analyte polynucleotide” and “analyte strand” refer to a single- or double-stranded polynucleotide which is suspected of containing a target sequence, and which may be present in a variety of types of samples, including biological samples.

### III. CGH Arrays, Methods of Making, and Use Thereof

The methods of the invention utilizes genomic microarrays, such as BAC microarrays, for comparative genomic hybridization (CGH).

Genomic DNA microarray-based comparative genomic hybridization (CGH) has the potential to solve many of the limitations of traditional CGH method, which relies on comparative hybridization on individual or the entire set of metaphase chromosomes. In metaphase CGH, multi-megabase fragments of different samples of genomic DNA (e.g., known normal sample versus test sample, e.g., a possible tumor) are labeled and hybridized to a fixed chromosome (see, e.g., Breen, J. Med. Genetics 36: 511-517, 1999; Rice, Pediatric Heniiatol. Oncol. 17: 141-147, 2000) or to a complete genomic set of chromosomes present in a metaphase preparation. Signal differences between known and test samples are detected and measured. In this way, missing, amplified, or unique sequences in the test sample, as compared to the “normal” control, can be detected by the fluorescence ratio of normal control to test genomic DNA. In metaphase CGH, the target sites (on the fixed chromosome or set of chromosomes) are saturated by an excess amount of soluble, labeled genomic DNA.

In contrast to metaphase CGH, where the immobilized genomic DNA is a metaphase spread, array-based CGH uses immobilized nucleic acids, each nucleic acid having a known segment of a genome cloned in a vector, arranged as an array on a biochip or a microarray platform. Another difference is that in array-based CGH, the immobilized genomic DNA is in molar excess as compared to the copy number of labeled (test and control) genomic nucleic acid. Under such conditions, suppression of repetitive genomic sequences and cross hybridization on the immobilized DNA is very helpful for reliable detection and quantitation of copy number differences between normal control and test samples.

The so-called microarray or chip CGH approach can provide DNA sequence copy number information across the entire genome in a single, timely, cost effective and sensitive procedure, the resolution of which is primarily dependent upon the number, size and map positions of the DNA elements within the array. Typically, the known genomic segments are cloned in a bacterial artificial chromosomes, or BAC, which is the vector that can accommodate on average about 150 kilobases (kb) of cloned genomic DNA, is used in the production of the array. However, other sources of genomic DNA's in other vector sources may be used, including P1 phage-based vector (PAC), cosmid, yeast artificial chromosome (YAC), mammalian artificial chromosome (MAC), human artificial chromosome, or even plasmid or viral-based vector, which may contain genomic DNA inserts of relatively small size (such as 500 bp to 2 kb). These different vector choices provide a range of genomic DNA fragment sizes for use in experiments of different resolution. Large genomic DNA fragments may be used for initial screening of large, unknown aberrations in certain diseases, while high resolution small clones may be used for assaying a pre-determined region harboring a specific mutation. The small fragment size arrays may also be used for high resolution whole genome screen, but such use may need to use a significantly higher number of genomic DNA clones (arrays).

For BAC clones, NCBI maintains a human BAC resource, which provides genome-wide resource of large-insert clones that will help integrate cytogenetic, radiation-hybrid, linkage, and sequence maps of the human genome. The BAC clones are placed on NCBI contigs. Only clones that are localized to one or two places on the same chromosome on the draft sequence are included in the count, and the data are constantly updated. See www.ncbi.nlm.nih.gov/genome/cyto/hbrc.shtml.

NCBI also maintains a SKY/M-FISH and CGH database, which is aimed to provide a public platform for investigators to share and compare their molecular cytogenetic data. The database is open to everyone and all users can view an individual investigator's public data, or compare public cases from different investigators using the web-based tools provided by NCBI. Such data can also be used in the methods of the instant invention. See www.ncbi.nlm.nih.gov/sky.

The principle of the array CGH approach is simple (see WO9318186A1). Equitable amounts of total genomic DNA from cells of a test sample and a reference sample (e.g., a sample from cells known to be free of chromosomal aberrations) are differentially labeled with fluorescent dyes and co-hybridized to the array of BACs (or any other genomic clones of suitable lengths, such as YAC, PAC, MAC, or P1 clones), which contain the cloned genomic DNA fragments that collectively cover the cell's genome. The resulting co-hybridization produces a fluorescently labeled array, the coloration of which reflects the competitive hybridization of sequences in the test and reference genomic DNAs to the homologous sequences within the arrayed BACs. Theoretically, the copy number ratio of homologous sequences in the test and reference genomic DNA samples should be directly proportional to the ratio of their respective fluorescent signal intensities at discrete BACs within the array. The versatility of the approach allows the detection of both constitutional variations in DNA copy number in clinical cytogenetic samples such as amniotic samples, chorionic villus samples (CVS), blood samples and tissue biopsies as well as somatically acquired changes in tumorigenically altered cells, for example, from bone marrow, blood or solid tumor samples.

WO 03/020898 A2 describes in detail the basic CGH methods, the arrays suitable for carrying out the method. The entire content of WO 03/020898 A2 is incorporated herein by reference. The same methods can also be used to manufacture arrays useful for diagnosis and prognosis, once the subset of genomic regions/genes are identified using the methods of the invention.

Instead of generating arrays of genomic DNA using methods described above, various BAC array products are commercially available and can be used directly for the methods of the invention. For example, Spectral Genomics Inc. (Houston, Tex.) provides SpectralChip Human BAC Arrays suitable for conducting microarray-based CGH. SpectralChip arrays generate a genome wide molecular profile and quantification of chromosomal imbalances on a single chip. Such microarray chips can be used to detect chromosomal imbalances, which are common events in most solid tumors.

The Human SpectralChip™ (Spectral Genomics, Inc. Houston, Tex. Kits are available as complete hybridization systems. For example, one of these kit includes two arrays with 2632 non-overlapping BAC clones printed in duplicate on a glass slide from the RPCI BAC library, along with the necessary reagents and solutions for labeling and hybridization. The BACs span the genome at approximately 1 Mb intervals, that enables the detection of aberrations as small as those that that can hybridize to a single clone or portion of the sequence of a single clone Mb. However, if finer coverage is desired, BAC clones can be arrayed in closer proximity allowing overlap and tiling of the genome for resolution as high as 45 kilo bases, Other formats having different numbers of clones in duplicate or triplicate are also within the scope of the invention, for example, 50 clones, 100 clones, 500 clones, 1000 clones, 5,000 or as many as the entire know BAC library of 32,000 clones can be present on an array. Spectral Genomics' platform technology enables users to markedly increase the signal sensitivity, specificity, reproducibility, and utility of SpectralChip microarrays.

Spectral Genomics' chemical attachment used in manufacturing such chips is fundamentally different from all traditional microarray techniques. Contrary to the modification of the surface by chemicals like poly-L-lysine or silane to attach unmodified DNA, Spectral Genomics' core technology is based on a unique proprietary chemical coupling of large DNA fragments to untreated surfaces. DNA glass microarrays produced by this method have several major advantages over traditional glass microarrays, for example, reduction in non-specific hybridization of labeled samples to the glass.

### IV. Statistical Analysis of CGH Data

Chromosomal changes that were observed in at least 2 patients are first put into a univariate model to determine correlation with a number of diagnostic/prognostic factors, such as patient age, pre-operative PSA, pathologic Gleason score, pathologic stage, and PSA recurrence, etc. in prostate cancer. A multivariate model can then be constructed, incorporating only the statistically significant chromosomal changes as well as certain selected diagnostic/prognostic factors (such as Gleason score, pathologic stage, and preoperative PSA to analyze factors contributing to PSA progression in prostate cancer).

The correlation coefficient, a concept from statistics is a measure of how well trends in the predicted values follow trends in the actual observed values. It is a measure of how well the predicted values from a forecast model “fit” with the real-life data. More specifically, the correlation coefficient measures the strength of the linear association between two interval/ratio scale variables. (Bivariate relationships are denoted with a small r). This parameter does not distinguish explanatory from response variables and is not affected by changes in the unit of measurement of either or both variables (see Moore, D., and G. McCabe, 1993; Introduction to the Practice of Statistics, (W.H. Freeman and Company, New York, 854p)).

The correlation coefficient is a number between 0 and 1. If there is no relationship between the predicted values and the actual values the correlation coefficient is 0 or very low (the predicted values are no better than random numbers). As the strength of the relationship between the predicted values and actual values increases so does the correlation coefficient. A perfect fit gives a coefficient of 1.0. Thus the higher the correlation coefficient the better is the fit of the data to the theory being tested.

Multiple correlation coefficient R is a value between 0 and 1 (compare: −1<=r<=1), (or the multiple coefficient of determination, 0<=R2<=1). It is the proportion of effects of a single dependent variable (Y) that can be attributed to the combined effects of all the X independent variables acting together. Thus for net effects of multivariate, assess R, R2; for individual effects (bivariate), assess r, r2.

Multiple Correlation And Regression

Regression analyses are a set of statistical techniques that allow one to assess the relationship between one dependent variable (DV) and several independent variables (IVs). Multiple regression is an extension of bivariate regression. In multiple regression analysis, several IVs are combined to predict the DV. Regression may be assessed in a variety of manners, such as:
partial regression and correlation:
   Isolates the specific effect of a particular independent variable controlling for the effects of other independent variables. The relationship between pairs of variables is evaluated, while recognizing the relationship with other variables.
multiple regression and correlation:
   combined effect of all the variables acting on the dependent variable; for a net, combined effect. The resulting R2 value provides an indication of the goodness of fit of the model. The multivariate regression equation is of the form:

Y=A+B₁X₁+B₂X₂+ . . . +BₖXₖ+E
where:
Y=the predicted value on the DV,
A=the Y intercept, the value of Y when all Xs are zero,
Xₖ=the various IVs,
B=the various coefficients assigned to the IVs during the regression,
E=an error term.

Accordingly, a different Y value is derived for each different case of IV. The goal of the regression is then to derive the B values, the regression coefficients, or beta coefficients. The beta coefficients allow the computation of reasonable Y values with the regression equation, and provide that calculated values are close to actual measured values. Computation of the regression coefficients provides two major results:
minimization of deviations (residuals) between predicted and obtained Y values for the data set,
optimization of the correlation between predicted and obtained Y values for the data set.

As a result the correlation between the obtained and predicted values for Y relate the strength of the relationship between the DV and IVs.

Although regression analyses reveal relationships between variables this does not imply that the relationships are causal. Demonstration of causality is not a statistical problem, but an experimental and logical problem. The ratio of cases to independent variables must be large to avoid a meaningless (perfect) solution. As with more IVs than cases, a regression solution may be found which perfectly predicts the DV for each case. As a rule of thumb, approximately 20 times more cases than IVs is preferred for good results, yet at a bare minimum 5 times more cases than IVs may be used. Extreme cases (outliers) have a strong effect on the regression solution and should be dealt with. Calculation of the regression coefficients requires matrix inversion, which is possible only when the variables are not multicollinear or singular. The examination of residual plots will assist in the assessment that the results meet the assumptions of normality, linearity, and homoscedasticity between predicted DV scores and errors of prediction. The assumptions of the analysis are:
that the residuals (the difference between predicted and obtained scores) are normally distributed,
that the residuals have a straight line relationship with predicted DV scores, and the variance of the residual about the predicted scores is the same for all predicted scores, i.e., are homoscedastic.

Prior to processing of the data as input to a multiple regression model the data should be screened. Regression computation cam be carried out using various software programs, or according to the principles set forth in Wetherill, G., 1986; Regression Analysis with Applications (Chapman and Hall, New York, 311p) and Weslowsky, G., 1976; Multiple Regression and Analysis of Variance, (John Wiley & Sons, Toronto, 292p). One caveat is that, the simple mathematics involved, and the ubiquity of programs capable of computing regression, may result in the misuse of regression procedures. Such problems are also described in Tabachnick and Fidell (supra), and Weslowsky (supra).

Some statistical analysis packages, such as SPSS, generate a VIF and tolerance value, the VIF, or variance inflation factor, will reflect the presence or absence of multicollinearity. At a high VIF, larger than one, the variable may be affected by multicollinearity. The VIF has a range 1 to infinity. Tolerance has a range from zero to one. The closer the tolerance value is to zero relates a level of multicollinearity. As mentioned above, the results of the regression should be assessed to reflect the quality of the model, especially if the data was not screened.

In a GM-CGH experiment of the instant invention, two genomic DNA samples are simultaneously hybridized to microarrays, and the hybridization signal may be detected with different fluorochromes. The intensity ratio of the two fluorescence signals gives a measure for the copy number ratio between the two genomic DNA samples. For the objective identification of such imbalances, quantitative fluorescence digital image analysis is necessary. Such analysis, for example, can be performed using a complete semi-automatic system for CGH analysis runs under MS-Windows on an IBM-PC (or other compatible computers). Other operating systems (UNIX, Mac, etc.) may also be adapted for this use accordingly.

To obtain quantitative, reliable, and reproducible results, an accurate measurement of fluorescence intensities is necessary. Many image operations may be performed to make digitized images in order to improve the statistical fidelity of the detected genetic alterations by averaging. Thus, a quantitative fluorescence image processing system connected with a highly sensitive CCD camera may be used for such an analysis.

For example, images may be acquired through a Zeiss Axiophot fluorescence microscope using a Plan NEOFLUAR oil objective×63, N.A. 1.25 (Zeiss, Oberkochen, Germany) equipped with filter sets appropriate for DAPI (Zeiss filter set 02, excitation: G365, beamsplitter: FT 395, emission: LP 420), FITC (Zeiss filter set 10, excitation: BP 450-490, beamsplitter: FT 510, emission: BP 515-565) and TRITC (Chroma filter set HQ Cy3+excitation filter from Zeiss filter set 15, excitation: BP 546/12, beamsplitter: FT 565, emission: BP 570-650) with a cooled CCD camera (Photometrics, Tucson, Ariz., U.S.A.) connected to a Macintosh Quadra 950 (U.S.A.). The resolution of this particular apparatus configuration is roughly 0.108 m/pixel. The maximum image size may be set at 1320×1035×12 bit. Other suitable filter sets may be used depending on the specific dyes used in the experiments.

A 100 W mercury lamp and the diaphragms of the microscope may be precisely adjusted to get a homogeneous illumination of the optical field. For each image, 2-3 gray-level images can be digitized, one image for each fluorochrome. Image sizes of 512×512 or 768×768 pixels, for example, can be chosen. The images may be inverted in order to make it possible to use the standard segmentation process and transferred as 8 bit TIFF-files to a server PC via a local area network.

Alternatively, for image acquiring purpose, a laser scanner may be used instead of or in additional to a CCD camera. Other suitable image capture and/or analysis devices may also be used in the instant invention.

Image processing may be carried out with any suitable image analysis software, such as those modified and extended for the CGH purpose. The program may comprise the following steps: computation of the fluorescence ratio images between dye 1 and dye 2 images; calculating ratio, presentation/storage of results.

Ratios of fluorescent intensity may be selectively acquired from selected areas of the array (corresponding to specific chromosomal regions/loci) based on user setting. Such specific chromosomal regions/loci may correspond to specific disease conditions of interest.

### V. Sample Amplification

In certain embodiment of the invention, samples to be analyzed using the subject method may be in limited amount. Under those circumstances, it might be desirable to amplify the genomic DNA from the sample before the GM-CGH analysis.

One advantage of sample pre-amplification is to preserve limited supplied of sample source. Certain samples may originate from frozen tissues, such as archived tissue samples dissected from patients many years ago. Certain other tissues may be in limited supply due to the method of obtaining such samples, such as fine needle biopsy (FNB), or collected body fluids with loose cells (e.g. blood, serum, urine samples, etc.).

This step is particularly advantageous in various diagnosis/prognosis uses.

It is also useful for identifying correlations between particular genomic abberations and disease outcomes. Archived tissue samples may be of particular interest in this regard. There are a large number of available archived tissue samples, rendering it possible to conduct more accurate and powerful statistic analysis. Furthermore, many of these samples were obtained from patients years ago, and the final clinical outcome of these patients are now known. Thus any genomic abberations detected in these archived samples may be matched with the actual clinical outcomes, providing a large database of genomic abberations and their associated clinical results.

In certain embodiments, the entire genomic DNA from all sample cells are amplified to the same extent (“whole genome amplification,” or WGA), such that the relative proportion of all genomic DNA (e.g. normal and abnormal parts of the genome) is maintained in the amplified sample as compared to the original sample.

For example, the whole genome of each of a plurality of patient tissue samples may be amplified according to this method before GM-CGH analysis. This unbiased amplification provides a genome profile for each tissue sample, which profiles can be further used to analyze the correlation, if any, between a particular clinical outcome and any profile changes.

In certain other embodiments, the genomic DNA from the sample may be selectively amplified, such that only portions of the whole genome is amplified for GM-CGH analysis.

For example, if abberations in a (or a few) known genomic region(s) is known to be associated with a particular disease, it might be possible to selectively amplify genomic regions associated with these particular disease genes. These selectively amplified samples will provide the same assay result, but with enhanced sensitivity (e.g. capable of detecting changes in smaller amount of tissue samples) and larger signal/noise ratio (since the proportion of disease genes has increased in the amplified samples).

There are many suitable amplification methods that can be adapted for use in the instant application. Some are described below as non-limiting illustrative examples.

PCR™ is a powerful technique to amplify DNA (Saiki, 1985). This in vitro technique amplifies DNA by repeated thermal denaturation, primer annealing and polymerase extension, thereby amplifying a single target DNA molecule to detectable quantities. PCR™ is not particularly amenable to the amplification of long DNA molecules such as entire chromosomes, which in humans are approximately 3×10⁹ bases in length. The commonly used polymerase in PCR reactions is Taq™ polymerase, which typically cannot amplify regions of DNA larger than about 5000 bases. Moreover, knowledge of the exact nucleotide sequences flanking the amplification target is necessary in order to design primers used in the PCR reaction.

Whole genome PCR™ results in the amplification either of complete pools of DNA or of unknown intervening sequences between specific primer binding sites. The amplification of complete pools of DNA, termed “known amplification” (Lüidecke et al., 1989) or “general amplification” (Telenius et al., 1992), can be achieved by different means. Common to all approaches is the capability of the PCR™ system to unanimously amplify DNA fragments in the reaction mixture without preference for specific DNA sequences. The structure of primers used for whole genome PCR™ is described as totally degenerate (i.e., all nucleotides are termed N,N=A, T, G, C), partially degenerate (i.e., several nucleotides are termed N) or non-degenerate (i.e., all positions exhibit defined nucleotides).

Whole genome PCR™ involves converting total genomic DNA to a form which can be amplified by PCR (Kinzler and Vogelstein, 1989). In this technique, total genomic DNA is fragmented via shearing or enzymatic digestion with, for instance, a restriction enzyme such as Mbo I, to an average size of 200-300 base pairs. The ends of the DNA are made blunt by incubation with the Klenow fragment of DNA polymerase. The DNA fragments are ligated to catch linkers consisting of a 20 base pair DNA fragment synthesized in vitro. The catch linkers consist of two phosphorylated oligomers: 5′-GAGTAGAATTCTAATATCTA-3′ (SEQ ID NO: 1) and 5′-GAGATATTAGAATTCTACTC-3′ (SEQ ID NO: 2). To select against the “catch” linkers that were self-ligated, the ligation product is cleaved with XhoI. Each catch linker has one half of an XhoI site at its termini; therefore, XhoI cleaves catch linkers ligated to themselves but will not cleave catch linkers ligated to most genomic DNA fragments. The linked DNA is in a form that can be amplified by PCR™ using the catch oligomers as primers. The DNA of interest can then be selected via binding to a specific protein or nucleic acid and recovered. The small amount of DNA fragments specifically bound can be amplified using PCR™. The steps of selection and amplification may be repeated as often as necessary to achieve the desired purity.

Whole Genome PCR™ May be Performed with Non-Degenerate Primers.

Lone Linker PCR™: Because of the inefficiency of the conventional catch linkers due to self-hybridization of two complementary primers, asymmetrical linkers for the primers were designed (Ko et al., 1990). The sequences of the catch linker oligonucleotides (Kinzler and Vogelstein, 1989) were used with the exception of a deleted 3 base pair sequence from the 3′-end of one strand. This “lone-linker” has both a non-palindromic protruding end and a blunt end, thus preventing multimerization of linkers. Moreover, as the orientation of the linker was defined, a single primer was sufficient for amplification. After digestion with a four-base cutting enzyme, the lone linkers were ligated. Lone-linker PCR™ (LL-PCR™) produces fragments ranging from 100 bases to about 2 kb that were reported to be amplified with similar efficiency.

Interspersed Repetitive Sequence PCR™: As used for the general amplification of DNA, interspersed repetitive sequence PCR™ (IRS-PCR™) uses non-degenerate primers that are based on repetitive sequences within the genome.

This allows for amplification of segments between suitable positioned repeats and has been used to create human chromosome- and region-specific libraries (Nelson et al., 1989). IRS-PCR™ is also termed Alu element mediated-PCR™ (ALU-PCR™), which uses primers based on the most conserved regions of the Alu repeat family and allows the amplification of fragments flanked by these sequences (Nelson et al., 1989). A major disadvantage of IRS-PCR™ is that abundant repetitive sequences like the Alu family are not uniformly distributed throughout the human genome, but preferentially found in certain areas (e.g., the light bands of human chromosomes) (Korenberg and Rykowski, 1988). Thus, IRS-PCR™ results in a bias toward these regions and a lack of amplification of other, less represented areas. Moreover, this technique is dependent on the knowledge of the presence of abundant repeat families in the genome of interest.

Linker Adapter PCR™: The limitations of IRS-PCR™ are abated to some extent using the linker adapter technique (LA-PCR™) (Luidecke et al., 1989; Saunders et al., 1989; Kao and Yu, 1991). This technique amplifies unknown restricted DNA fragments with the assistance of ligated duplex oligonucleotides (linker adapters). DNA is commonly digested with a frequently cutting restriction enzyme such as RsaI, yielding fragments that are on average 500 bp in length. After ligation, PCR™ can be performed using primers complementary to the sequence of the adapters. Temperature conditions are selected to enhance annealing specifically to the complementary DNA sequences, which leads to the amplification of unknown sequences situated between the adapters. Post-amplification, the fragments are cloned. There should be little sequence selection bias with LA-PCR™ except on the basis of distance between restriction sites. Methods of LA-PCR™ overcome the hurdles of regional bias and species dependence common to IRS-PCR™. However, LA-PCR™ is technically more challenging than other whole genome amplification (WGA) methods.

A large number of band-specific microdissection libraries of human, mouse, and plant chromosomes have been established using LA-PCR™ (Chang et al., 1992; Wesley et al., 1990; Saunders et al., 1989; Vooijs et al., 1993; Hadano et al., 1991; Miyashita et al., 1994). PCR™ amplification of a microdissected region of a chromosome is conducted by digestion with a restriction enzyme (e.g., Sau3A, MboI) to generate a number of short fragments, which are ligated to linker-adapter oligonucleotides that provide priming sites for PCR™ amplification (Saunders et al., 1989). Two oligonucleotides, a 20-mer and a 24-mer creating a 5′ overhang that was phosphorylated with T4 polynucleotide kinase and complementary to the end generated by the restriction enzyme, were mixed in equimolar amounts and allowed to anneal. Following this amplification, as much as 1 μg of DNA can be amplified from as little as one band dissected from a polytene chromosome (Saunders et al., 1989; Johnson, 1990). Ligation of a linker-adapter to each end of the chromosomal restriction fragment provides the primer-binding site necessary for in vitro semiconservative DNA replication. Other applications of this technology include amplification of one flow-sorted mouse chromosome 11 and use of resulting DNA library as a probe in chromosome painting (Miyashita et al., 1994), and amplification of DNA of a single flow-sorted chromosome (VanDeanter et al., 1994).

A different adapter used in PCR™ is the Vectorette (Riley et al., 1990). This, technique is largely used for the isolation of terminal sequences from yeast artificial chromosomes (YAC) (Kleyn et al., 1993; Naylor et al., 1993; Valdes et al., 1994). Vectorette is a synthetic oligonucleotide duplex containing an overhang complementary to the overhang generated by a restriction enzyme. The duplex contains a region of non-complementarity as a primer-binding site. After ligation of digested YACs and a Vectorette unit, amplification is performed between primers identical to Vectorette and primers derived from the yeast vector. Products will only be generated if, in the first PCR™ cycle, synthesis has taken place from the yeast vector primer, thus synthesizing products from the termini of YAC inserts.

Priming Authorizing Random Mismatches PCR™: Another whole genome PCR: method using non-degenerate primers is Priming Authorizing Random Mismatches-PCR™ (PARM-PCR™), which uses specific primers and unspecific annealing conditions resulting in a random hybridization of primers leading to universal amplification (Milan et al., 1993). Annealing temperatures are reduced to 30° C. for the first two cycles and raised to 60° C. in subsequent cycles to specifically amplify the generated DNA fragments. This method has been used to universally amplify flow sorted porcine chromosomes for identification via fluorescent in situ hybridization (FISH) (Milan et al., 1993). A similar technique was also used to generate chromosome DNA clones from microdissected DNA (Hadano et al., 1991). In this method, a 22-mer primer unique in sequence, which randomly primes and amplifies any target DNA, was utilized. The primer contained recognition sites for three restriction enzymes. Thermocycling was done in three stages: stage one had an annealing temperature of 22° C. for 120 minutes, and stages two and three were conducted under stringent annealing conditions.

Single Cell Comparative Genomic Hybridization: A method allowing the comprehensive analysis of the entire genome on a single cell level has been developed termed single cell comparative genomic hybridization (SCOMP) (Klein et al., 1999; WO 00/1 7390, incorporated herein by reference). Genomic DNA from a single cell is fragmented with a four base cutter, such as MseI, giving an expected average length of 256 bp (44) based on the premise that the four bases are evenly distributed. Ligation mediated PCR™ was utilized to amplify the digested restriction fragments. Briefly, two primers ((5′-AGTGGGATTCCGCATGCTAGT-3′; SEQ ID NO: 3); and (5′-TAACTAGCATGC-3′; SEQ ID NO: 4)); were annealed to each other to create an adapter with two 5′ overhangs. The 5′ overhang resulting from the shorter oligo is complementary to the ends of the DNA fragments produced by MseI cleavage. The adapter was ligated to the digested fragments using T4 DNA ligase. Only the longer primer was ligated to the DNA fragments as the shorter primer did not have the 5′ phosphate necessary for ligation. Following ligation, the second primer was removed via denaturation, and the first primer remained ligated to the digested DNA fragments. The resulting 5′ overhangs were filled in by the addition of DNA polymerase. The resulting mixture was then amplified by PCR™ using the longer primer.

As this method is reliant on restriction digests to fragment the genomic DNA, it is dependent on the distribution of restriction sites in the DNA. Very small and very long restriction fragments will not be effectively amplified, resulting in a biased amplification. The average fragment length of 256 generated by MseI cleavage will result in a large number of fragments that are too short to amplify.

Whole Genome PCR™ with Degenerate Primers.

In order to overcome certain problems associated with many techniques using non-degenerate primers for universal amplification, techniques using partially or totally degenerate primers were developed for universal amplification of minute amounts of DNA.

Degenerate oligonucleotide-primed PCR™ (DOP-PCR™) was developed using partially degenerate primers, thus providing a more general amplification technique than IRS-PCR (Wesley et al., 1990; Telenius, 1992). A system was described using non-specific primers (5′-TTGCGGCCGCATTNNNNTTC-3′ (SEQ ID NO: 5); showing complete, degeneration at positions 4, 5, 6, and 7 from the 3′ end (Wesley et al., 1990). The three specific bases at the 3′ end are statistically expected to hybridize every 64 (43) bases, thus the last seven bases will match due to the partial degeneration of the primer. The first cycles of amplification are conducted at a low annealing temperature (30° C.), allowing sufficient priming to initiate DNA synthesis at frequent intervals along the template. The defined sequence at the 3 ′ end of the primer tends to separate initiation sites, thus increasing product size. As the PCR product molecules all contain a common specific 5′ sequence, the annealing temperature is raised to 56° C. after the first eight cycles. The system was developed to non-specifically amplify microdissected chromosomal DNA from Drosophila, replacing the microcloning system of Lüdecke et al. (1989) described above.

The term DOP-PCR™ was introduced by Telenius et al. (1992) who developed the method for genome mapping research using flow sorted chromosomes. A single primer is used in DOP-PCR™ as used by Wesley et al. (1990). The primer (5′-CCGACTCGACNNNNNNATGTGG-3′ (SEQ ID NO: 6); shows six specific bases on the 3′-end, a degenerate part with 6 bases in the middle and a specific region with a rare restriction site at the 5′-end. Amplification occurs in two stages. Stage one encompasses the low temperature cycles. In the first cycle, the 3′-end of the primers hybridize to multiple sites of the target DNA initiated by the low annealing temperature. In the second cycle, a complementary sequence is generated according to the sequence of the primer. In stage two, primer annealing is performed at a temperature restricting all non-specific hybridization. Up to 10 low temperature cycles are performed to generate sufficient primer binding sites. Up to 40 high temperature cycles are added to specifically amplify the prevailing target fragments.

DOP-PCR™ is based on the principle of priming from short sequences specified by the 3 ′-end of partially degenerate oligonucleotides used during initial low annealing temperature cycles of the PCR™ protocol. As these short sequences occur frequently, amplification of target DNA proceeds at multiple loci simultaneously. DOP-PCR™ is applicable to the generation of libraries containing high levels of single copy sequences, provided uncontaminated DNA in a substantial amount is obtainable (e.g., flow-sorted chromosomes). This method has been applied to less than one nanogram of starting genomic DNA (Cheung and Nelson, 1996).

Advantages of DOP-PCR™ in comparison to systems of totally degenerate primers are the higher efficiency of amplification, reduced chances for unspecific primer-primer binding and the availability of a restriction site at the 5′ end for further molecular manipulations. However, DOP-PCR™ does not claim to replicate the target DNA in its entirety (Cheung and Nelson, 1996). Moreover, as relatively short products are generated, specific amplification of fragments up to approximately 500 bp in length are produced (Telenius et al., 1992; Cheung and Nelson, 1996; Wells et al., 1999; Sanchez-Cespedes et al., 1998; Cheung et al., 1998).

In light of these limitations, a method has been described that produces long DOP-PCR™ products ranging from 0.5 to 7 kb in size, allowing the amplification of long sequence targets in subsequent PCR (long DOP-PCR™) (Buchanan et al., 2000). However, long DOP-PCR utilizes 200 ng of genomic DNA, which is more DNA than most applications will have available. Subsequently, a method was described that generates long amplification products from picogram quantities of genomic DNA, termed long products from low DNA quantities DOP-PCR™ (LL-DOP-PCR™) (Kittler et al., 2002). This method achieves this by the 3-5′ exonuclease proofreading activity of DNA polymerase Pwo and an increased annealing and extension time during DOP-PCR™, which are necessary steps to generate longer products. Although an improvement in success rate was demonstrated in comparison with other DOP-PCR™ methods, this method did have a 15.3% failure rate due to complete locus dropout for the majority of the failures and sporadic locus dropout and allele dropout for the remaining genotype failures. There was a significant deviation from random expectations for the occurrence of failures across loci, thus indicating a locus-dependent effect on whole genome coverage.

Sequence Independent PCR™: Another approach using degenerate primers is described by Bohlander et al., (1992), called sequence-independent DNA amplification (SIA). In contrast to DOP-PCR™, SIA incorporates a nested DOP-primer system. The first primer (5′-TGGTAGCTCTTGATCANNNNN-3 ′ (SEQ ID NO: 7); consisted of a five base random 3′-segment and a specific 16 base segment at the 5′ end containing a restriction enzyme site. Stage one of PCR™ starts with 97° C. for denaturation, followed by cooling down to 4° C., causing primers to anneal to multiple random sites, and then heating to 37° C. A T7 DNA polymerase is used. In the second low-temperature cycle, primers anneal to products of the first round. In the second stage of PCR™, a primer (5′-AGAGTTGGTAGCTCTTGATC-3′ (SEQ ID NO:8); is used that contains, at the 3′ end, 15 5′-end bases of primer A. Five cycles are performed with this primer at an intermediate annealing temperature of 42° C. An additional 33 cycles are performed at a specific annealing temperature of 56° C. Products of SIA range from 200 bp to 800 bp.

Primer-extension Pre-amplification (PEP) is a method that uses totally degenerate primers to achieve universal amplification of the genome (Zhang et al., 1992). PEP uses a random mixture of 15-base fully degenerated oligonucleotides as primers, thus any one of the four possible bases could be present at each position. Theoretically, the primer is composed of a mixture of 4×10⁹ different oligonucleotide sequences. This leads to amplification of DNA sequences from randomly distributed sites. In each of the 50 cycles, the template is first denatured at 92° C. Subsequently, primers are allowed to anneal at a low temperature (37° C.), which is then continuously increased to 55° C. and held for another four minutes for polymerase extension.

A method of improved PEP (I-PEP) was developed to enhance the efficiency of PEP, primarily for the investigation of tumors from tissue sections used in routine pathology to reliably perform multiple microsatellite and sequencing studies with a single or few cells (Dietmaier et al., 1999). I-PEP differs from PEP (Zhang et al., 1992) in cell lysis approaches, improved thermal cycle conditions, and the addition of a higher fidelity polymerase. Specifically, cell lysis is performed in EL buffer, Taq polymerase is mixed with proofreading Pwo polymerase, and an additional elongation step at 68° C. for 30 seconds before the denaturation step at 94° C. was added. This method was more efficient than PEP and DOP-PCR™ in amplification of DNA from one cell and five cells.

Both DOP-PCR™ and PEP have been used successfully as precursors to a variety of genetic tests and assays. These techniques are integral to the fields of forensics and genetic disease diagnosis where DNA quantities are limited. However, neither technique claims to replicate DNA in its entirety (Cheung and Nelson, 1996) or provide complete coverage of particular loci (Paunio et al., 1996). These techniques produce an amplified source for genotyping or marker identification. The products produced by these methods are consistently short (<3 kb) and as such cannot be used in many applications (Telenius et al., 1992). Moreover, numerous tests are required to investigate a few markers or loci.

Tagged PCR™ (T-PCR™) was developed to increase the amplification efficiency of PEP in order to amplify efficiently from small quantities of DNA samples with sizes ranging from 400 bp to 1.6 kb (Grothues et al., 1993). T-PCR™ is a two-step strategy, which uses, for the first few low-stringent cycles, a primer with a constant 17 base pair at the 5′ end and a tagged random primer containing 9 to 15 random bases at the 3 ′ end. In the first PCR™ step, the tagged random primer is used to generate products with tagged primer sequences at both ends, which is achieved by using a low annealing temperature. The unincorporated primers are then removed and amplification is carried out with a second primer containing only the constant 5′ sequence of the first primer under high-stringency conditions to allow exponential amplification. This method is more labor intensive than other methods due to the requirement for removal of unincorporated degenerate primers, which also can cause the loss of sample material. This is critical when working with subnanogram quantities of DNA template. The unavoidable loss of template during the purification steps could affect the coverage of T-PCR™. Moreover, tagged primers with 12 or more random bases could generate non-specific products resulting from primer-primer extensions or less efficient elimination of these longer primers during the filtration step.

Tagged Random Hexamer Amplification: Based on problems related to T-PCR™, tagged random hexamer amplification (TRHA) was developed on the premise that it would be advantageous to use a tagged random primer with shorter random bases (Wong et al., 1996). In TRHA, the first step is to produce a size distributed population of DNA molecules from a pNL1 plasmid. This was done via a random synthesis reaction using Klenow fragment and random hexamer tagged with T7 primer at the 5 ′-end (T7-dN6, 5′-GTAATACGACTCACTATAGGGCNNNNNN-3′ (SEQ ID NO: 9). Klenow-synthesized molecules (size range 28 bp-<23 kb) were then amplified with T7 primer (5 ′-GTAATACGACTCACTATAGGGC-3 ′ (SEQ ID NO: 10). Examination of bias indicated that only 76% of the original DNA template was preferentially amplified and represented in the TRHA products.

Strand Displacement: The isothermal technique of rolling circle amplification (RCA) has been developed for amplifying large circular DNA templates such as plasmid and bacteriophage DNA (Dean et al., 2001). Using 029 DNA polymerase, which synthesizes DNA strands 70 kb in length using random exonuclease-resistant hexamer primers, DNA was amplified in a 30° C. isothermal reaction. Secondary priming events occur on the displaced product DNA strands, resulting in amplification via strand displacement.

In this technique, two sets of primers are used. The right set of primers each have a portion complementary to nucleotide sequences flanking one side of a target nucleotide sequence, and primers in the left set of primers each have a portion complementary to nucleotide sequences flanking the other side of the target nucleotide sequence. The primers in the right set are complementary to one strand of the nucleic acid molecule containing the target nucleotide sequence, and the primers in the left set are complementary to the opposite strand. The 5′ end of primers in both sets is distal to the nucleic acid sequence of interest when the primers are hybridized to the flanking sequences in the nucleic acid molecule. Ideally, each member of each set has a portion complementary to a separate and non-overlapping nucleotide sequence flanking the target nucleotide sequence. Amplification proceeds by replication initiated at each primer and continuing through the target nucleic acid sequence. A key feature of this method is the displacement of intervening primers during replication. Once the nucleic acid strands elongated from the right set of primers reaches the region of the nucleic acid molecule to which the left set of primers hybridizes, and vice versa, another round of priming and replication commences. This allows multiples copies of a nested set of the target nucleic acid sequence to be synthesized.

Multiple Displacement Amplification: The principles of RCA have been extended to WGA in a technique called multiple displacement amplification (MDA) (Dean et al., 2002; U.S. Pat. No. 6,280,949 B1). In this technique, a random set of primers is used to prime a sample of genomic DNA. By selecting a sufficiently large set of primers of random or partially random sequence, the primers in the set will be collectively, and randomly, complementary to nucleic acid sequences distributed throughout nucleic acids in the sample. Amplification proceeds by replication with a highly possessive polymerase, φ29 DNA polymerase, initiating at each primer and continuing until spontaneous termination. Displacement of intervening primers during replication by the polymerase allows multiple overlapping copies of the entire genome to be synthesized.

The use of random primers to universally amplify genomic DNA is based on the assumption that random primers equally prime over the entire genome, thus allowing representative amplification. Although the primers themselves are random, the location of primer hybridization in the genome is not random, as different primers have unique sequences and thus different characteristics (such as different melting temperatures). As random primers do not equally prime everywhere over the entire genome, amplification is not completely representative of the starting material. Such protocols are useful in studying specific loci, but the result of random-primed amplification products is not representative of the starting material (e.g., the entire genome).

Other related arts also provide a variety of techniques for whole genome amplification. For example, Japan Patent No. JP8173 164A2 (incorporated herein by reference) describes a method of preparing DNA by sorting-out PCR™ amplification in the absence of cloning, fragmenting a double-stranded DNA, ligating a known-sequence oligomer to the cut end, and amplifying the resultant DNA fragment with a primer having the sorting-out sequence complementary to the oligomer. The sorting-out sequences consist of a fluorescent label and one to four bases at the 5′ and 3′ termini to amplify the number of copies of the DNA fragment.

U.S. Pat. No. 6,107,023 (incorporated herein by reference) describes a method of isolating duplex DNA fragments which are unique to one of two fragment mixtures, i.e., fragments which are present in a mixture of duplex DNA fragments derived from a positive source, but absent from a fragment mixture derived from a negative source. In practicing the method, double-strand linkers are attached to each of the fragment mixtures, and the number of fragments in each mixture is amplified by successively repeating the steps of (i) denaturing the fragments to produce single fragment strands; (ii) hybridizing the single strands with a primer whose sequence is complementary to the linker region at one end of each strand, to form strand/primer complexes; and (iii) converting the strand/primer complexes to double-stranded fragments in the presence of polymerase and deoxynucleotides. After the desired fragment amplification is achieved, the two fragment mixtures are denatured, then hybridized under conditions in which the linker regions associated with the two mixtures do not hybridize. DNA species unique to the positive-source mixture, i.e., which are not hybridized with DNA fragment strands from the negative-source mixture, are then selectively-isolated.

WO/016545 A1 (incorporated herein by reference) details a method for amplifying DNA or RNA using a single primer for use as a fingerprinting method. This protocol was designed for the analysis of microbial, bacterial and other complex genomes that are present within samples obtained from organisms containing even more complex genomes, such as animals and plants. The advantage of this procedure for amplifying targeted regions is the structure and sequence of the primer. Specifically, the primer is designed to have very high cytosine and very low guanine content, resulting in a high melting temperature. Furthermore, the primer is designed in such a way as to have a negligible ability to form secondary structure. This results in limited production of primer-dimer artifacts and improves amplification of regions of interest, without a priori knowledge of these regions. In contrast to the current invention, this method is only able to prime a subset of regions within a genome, due to the utilization of a single priming sequence. Furthermore, the structure of the primer contains only a constant priming region, as opposed to a constant amplification region and a variable priming region in the present invention. Thus, a single primer consisting of non-degenerate sequence results in priming of a limited number of areas within the genome, preventing amplification of the whole-genome.

U.S. Pat. No. 6,114,149 (incorporated herein by reference) regards a method of amplifying a mixture of different-sequence DNA fragments that may be formed from RNA transcription, or derived from genomic single- or double-stranded DNA fragments. The fragments are treated with terminal deoxynucleotide transferase and a selected deoxynucleotide to form a homopolymer tail at the 3′ end of the anti-sense strands, and the sense strands are provided with a common 3′-end sequence. The fragments are mixed with a homopolymer primer that is homologous to the homopolymer tail of the anti-sense strands, and a defined-sequence primer which is homologous to the sense-strand common 3′-end sequence, with repeated cycles of fragment denaturation, annealing, and polymerization, to amplify the fragments. In one embodiment, the defined-sequence and homopolymer primers are the same, i.e., only one primer is used. The primers may contain selected restriction-site sequences to provide directional restriction sites at the ends of the amplified fragments.

U.S. Pat. Nos. 6,124,120 and 6,280,949 (both incorporated herein by reference) describe compositions and a method for amplification of nucleic acid sequences based on multiple strand displacement amplification (MSDA). Amplification takes place not in cycles, but in a continuous, isothermal replication. Two sets of primers are used, a right set and a left set complementary to nucleotide sequences flanking the target nucleotide sequence. Amplification proceeds by replication initiated at each primer and continuation through the target nucleic acid sequence through displacement of intervening primers during replication. This allows multiple copies of a nested set of the target nucleic acid sequence to be synthesized in a short period of time. In another form of the method, referred to as whole genome strand displacement amplification (WGSDA), a random set of primers is used to randomly prime a sample of genomic nucleic acid. In an alternative embodiment, referred to as multiple strand displacement amplification of concatenated DNA (MSDA-CD), fragments of DNA are first concatenated together with linkers. The concatenated DNA is then amplified by strand displacement synthesis with appropriate primers. A random set of primers can be used to randomly prime synthesis of the DNA concatemers in a manner similar to whole genome amplification. Primers complementary to linker sequences can be used to amplify the concatemers. Synthesis proceeds from the linkers through a section of the concatenated DNA to the next linker, and continues beyond. As the linker regions are replicated, new priming sites for DNA synthesis are created. In this way, multiple overlapping copies of the entire concatenated DNA sample can be synthesized in a short time.

U.S. Pat. No. 6,365,375 (incorporated herein by reference) describes a method for primer extension pre-amplification of DNA with completely random primers in a pre-amplification reaction, and locus-specific primers in a second amplification reaction using two thermostable DNA polymerases, one of which possesses 3′-5′ exonuclease activity. Pre-amplification is performed by 20 to 60 thermal cycles. The method uses a slow transition between the annealing phase and the elongation phase. Two elongation steps are performed: one at a lower temperature and a second at a higher temperature. Using this approach, populations of especially long amplicons are claimed. The specific primers used in the second amplification reaction are identical to a sequence of the target nucleic acid or its complementary sequence. Specific primers used to carry out a nested PCR in a potential third amplification reaction are selected according to the same criteria as the primers used in the second amplification reaction. A claimed advantage of the method is its improved sensitivity to the level of a few cells and increased fidelity of the amplification due to the presence of proof-reading 3′-5′ exonuclease activity, as compared to methods using only one thermostable DNA polymerase, i.e. Taq polymerase.

WO 04/111266 A1 (incorporated herein by reference) describes a method for whole genome amplification comprising (a) treating genomic DNA with a modifying agent which modifies cytosine bases but does not modify 5′-methyl-cytosine bases under conditions to form single stranded modified DNA; (b) providing a population of random X-mers of exonuclease-resistant primers capable of binding to at least one strand of the modified DNA, wherein X is an integer 3 or greater; (c) providing polymerase capable of amplifying double stranded DNA, together with nucleotides and optionally any suitable buffers or diluents to the modified DNA; and (d) allowing the polymerase to amplify the modified DNA.

Bohlander et al. (Genomics. 13(4): 1322-4, 1992, incorporated herein by reference) have developed a method by which microdissected material can be amplified in two initial rounds of DNA synthesis with T7 DNA polymerase using a primer that contains a random five base sequence at its 3′ end and a defined sequence at its 5′ end. The pre-amplified material is then further amplified by PCR using a second primer equivalent to the constant 5′ sequence of the first primer.

Using modification of Bohlander's procedure and DOP-PCR, Guan et al. (Hum. Mol. Genet. 2(8): 1117-21, 1993, incorporated herein by reference) were able to increase sensitivity of amplification of microdissected chromosomes using DOP-PCR primers in a cycling pre-amplification reaction with Sequenase version 2 (replenished after each denaturing step by fresh enzyme) followed by PCR amplification with Taq polymerase.

Another modification of the original Bohlander's method has been published in a collection of protocols for DNA preparation in microarray analysis on the World Wide Web by the Department of Biochemistry and Biophysics at the University of California at San Francisco. This protocol has been used to amplify genomic representations of less than 1 ng of DNA. The protocol consists of three sets of enzymatic reactions. In Round A, Sequenase is used to extend primers containing a completely random sequence at its 3′ end and a defined sequence at its 5′ end to generate templates for subsequent PCR. During Round B, the specific primer B is used to amplify the templates previously generated. Finally, Round C consists of additional PCR cycles to incorporate either amino allyl dUTP or cyanine modified nucleotides.

Zheleznaya et al. (Biochemistry (Mosc). 64(4): 373-8, 1999, incorporated herein by reference) developed a method to prepare random DNA fragments in which two cycles are performed with Klenow fragment of DNA polymerase I and primers with random 3′-sequences and a 5′-constant part containing a restriction site. After the first cycle, the DNA is denatured and new Klenow fragment is added. Routine PCR amplification is then performed utilizing the constant primer.

US20040209298A1 (incorporated herein by reference) describes a variety of methods and compositions for whole genome amplification. Specifically, the publication describes a variety of new ways of preparing DNA templates, particularly for whole genome amplification, and preferentially in a manner representative of a native genome. In a particular aspect, there is a method of amplifying a genome comprising a library generation step followed by a library amplification step. In specific embodiments, the library generating step utilizes specific primer mixtures and a DNA polymerase, wherein the specific primer mixtures are designed to eliminate ability to self-hybridize and/or hybridize to other primers within a mixture but efficiently and frequently prime nucleic acid templates.

Although exponential amplification has the reputation of degrading the relative abundance relationships between transcripts, much of the bias can be attributed to the various steps required in generating the amplimers. The specific sequence of any given transcript may affect the efficiency of reverse transcription, and these effects may be exaggerated as the length of the transcript increases. Methods employing combinations of IVT-based and PCR-based amplification provide both a sensitive and a specific approach (Rosetta Inpharmatics, Inc. US006271002B1; Roche Diagnostics Co. US20030113754A1).

US20040209298A1 regards the amplification of a whole genome, including various methods and compositions to achieve that goal. In specific embodiments, a whole genome is amplified from a single cell, whereas in another embodiment the whole genome is amplified from a plurality of cells.

In a particular aspects, the method is directed to the amplification of substantially the entire genome without loss of representation of specific sites (e.g. “whole genome amplification”). In a specific embodiment, whole genome amplification comprises simultaneous amplification of substantially all fragments of a genomic library. In a further specific embodiment, “substantially entire” or “substantially all” refers to about 80%, about 85%, about 90%, about 95%, about 97%, or about 99% of all sequence in a genome. A skilled artisan recognizes that amplification of the whole genome will, in some embodiments, comprise non-equivalent amplification of particular sequences over others, although the relative difference in such amplification is not considerable.

In specific embodiments, the method regards immortalization of DNA following generation of a library comprising a representative amplifiable copy of the template DNA. The library generation step utilizes special self-inert degenerate primers designed to eliminate their ability to form primer-dimers and a polymerase comprising strand-displacement activity.

In one particular aspect, there is a method for uniform amplification of DNA using self-inert degenerate primers comprised essentially of non-self-complementary nucleotides. In specific embodiments, the degenerate oligonucleotides do not participate in Watson-Crick base-pairing with one another. This lack of primer complementarity overcomes major problems known in the art associated with DNA amplification by random primers, such as excessive primer-dimer formation, complete or sporadic locus dropout, generation of very short amplification products, and in some cases the inability to amplify single stranded, short, or fragmented DNA molecules.

In specific embodiments, the method provides a two-step procedure that can be performed in a single tube or in a micro-titer plate, for example, in a high throughput format. The first step (termed the “library synthesis step”) involves incorporation of known sequence at both ends of amplicons using highly degenerate primers and at least one enzyme possessing strand-displacement activity. The resulting branching process creates molecules having self-complementary ends. The resulting library of molecules are then amplified in a second step by PCR™ using, for example, Taq polymerase or any other like DNA polymerases, and a primer corresponding to the known sequence, resulting in several thousand-fold amplification of the entire genome without significant bias. The products of this amplification can be re-amplified additional times, resulting in amplification that exceeds, for example, several million fold.

Thus, in one particular aspect, there is a method of preparing a nucleic acid molecule, comprising obtaining at least one single stranded nucleic acid molecule; subjecting said single stranded nucleic acid molecule to a plurality of primers to form a single stranded nucleic acid molecule/primer mixture, wherein the primers comprise nucleic acid sequence that is substantially non-self-complementary and substantially non-complementary to other primers in the plurality, wherein said sequence comprises in a 5′ to 3 ′ orientation a constant region and a variable region; and subjecting said single stranded nucleic acid molecule/primer mixture to a strand-displacing polymerase, under conditions wherein said subjecting steps generate a plurality of molecules including all or part of the known nucleic acid sequence at each end.

The method may further comprise the step of designing the primers such that they purposefully are substantially non-self-complementary and substantially non-complementary to other primers in the plurality. The method may also further comprise the step of amplifying a plurality of the molecules comprising the known nucleic acid sequence to produce amplified molecules. Such amplification may comprise polymerase chain reaction, such as that utilizes a primer complementary to the known nucleic acid sequence.

The primers may comprise a constant region and a variable region, both of which include nucleic acid sequence that is substantially non-self-complementary and substantially non-complementary to other primers in the plurality. In specific embodiments, the constant region and variable region for a particular primer are comprised of the same two nucleotides, although the sequence of the two regions are usually different. The constant region is preferably known and may be a targeted sequence for a primer in amplification methods. The variable region may or may not be known, but in preferred embodiments is known. The variable region may be randomly selected or may be purposefully selected commensurate with the frequency of its representation in a source DNA, such as genomic DNA. In specific embodiments, the nucleotides of the variable region will prime at target sites in a source DNA, such as a genomic DNA, containing the corresponding Watson-Crick base partners. In a particular embodiment, the variable region is considered degenerate.

The single stranded nucleic acid molecule may be DNA in some embodiments.

In other aspects, a tag is incorporated on the ends of the amplified molecules, preferably wherein the known sequence is penultimate to the tags on each end of the amplified molecules. The tag may be a homopolymeric sequence, in specific embodiments, such as a purine. The homopolymeric sequence may be single stranded, such as a single stranded poly G or poly C. Also, the homopolymeric sequence may refer to a region of double stranded DNA wherein one strand of homopolymeric sequence comprises all of the same nucleotide, such as poly C, and the opposite strand of the double stranded region complementary thereto comprises the appropriate poly G.

The incorporation of the homopolymeric sequence may occur in a variety of ways known in the art. For example, the incorporation may comprise terminal deoxynucleotidyl transferase activity, wherein a homopolymeric tail is added via the terminal deoxynucleotidyl transferase enzyme. Other enzymes having analogous activities may be utilized, also. The incorporation of the homopolymeric sequence may comprise ligation of an adaptor comprising the homopolymeric sequence to the ends of the amplified molecules. An additional example of incorporation of the homopolymeric sequence employs replicating the amplified molecules with DNA polymerase by utilizing a primer comprising in a 5′ to 3 ′ orientation, the homopolymeric sequence, and the known sequence.

In additional embodiments of the present invention, the amplified molecules comprising the homopolymeric sequence are further amplified using a primer complementary to a known sequence and a primer complementary to the homopolymeric sequence. When the molecules comprise a guanine homopolymeric sequence, for example, the amplification of molecules with just the homo-cytosine primer is suppressed in favor of amplification of molecules with the primer complementary to a specific sequence (such as the known sequence) and the homo-cytosine primer. These embodiments may be utilized, for example, in the scenario wherein a small amount of DNA is available for processing, and it is converted into a library, amplified using universal primer, and then re-amplified or replicated with a new universal primer that has the same universal sequence at the 3′ end plus a homopolymeric (such as poly C) stretch at the 5 ′ end. This may then be used as an unlimited resource for targeted amplification/sequencing, for example, in specific embodiments.

In specific embodiments, the obtaining step may be further defined as comprising the steps of obtaining at least one double stranded DNA molecule and subjecting the double stranded DNA molecule to heat to produce at least one single stranded DNA molecule.

Nucleic acids processed by methods described herein may be DNA, RNA, or DNA-RNA chimeras, and they may be obtained from any useful source, such as, for example, a human sample. In specific embodiments, a double stranded DNA molecule is further defined as comprising a genome, such as, for example, one obtained from a sample from a human. The sample may be any sample from a human, such as blood, serum, plasma, cerebrospinal fluid, cheek scrapings, nipple aspirate, biopsy, semen (which may be referred to as ejaculate), urine (e.g. urine pellet), feces, hair follicle, saliva, sweat, immunoprecipitated or physically isolated chromatin, parafin-embedded tissues, and so forth. In specific embodiments, the sample comprises a single cell.

In particular embodiments of the present invention, the prepared nucleic acid molecule from the sample provides diagnostic or prognostic information. For example, the prepared nucleic acid molecule from the sample may provide genomic copy number and/or sequence information, allelic variation information, cancer diagnosis, prenatal diagnosis, paternity information, disease diagnosis, detection, monitoring, and/or treatment information, sequence information, and so forth.

In particular aspects, the primers are further defined as having a constant first and variable second regions each comprised of two non-complementary nucleotides.

The first and second regions may be each comprised of guanines, adenines, or both; of cytosines, thymidines, or both; of adenines, cytosines, or both; or of guanines, thymidines, or both. The first region may comprise about 6 to about 100 nucleotides. The second region may comprise about 4 nucleotides to about 20 nucleotides. The polynucleotide (primer) may be further comprised of 0 to about 3 random bases at its distal 3 ′ end. In particular embodiments, the nucleotides are base or backbone analogs.

In particular embodiments, the first region and the second region are each comprised of guanines and thymidines and the polynucleotide (primer) comprises about 1, 2, or 3 random bases at its 3′ end, although it may comprise 0 random bases at its 3′ end.

The known nucleic acid sequence may be used for subsequent amplification, such as with polymerase chain reaction.

In some embodiments, methods of the present invention utilize a strand-displacing polymerase, such as Φ29 Polymerase, Bst Polymerase, Vent Polymerase, 9° Nm Polymerase, Klenow fragment of DNA Polymerase I, MMLV Reverse Transcriptase, AMV reverse transcriptase, HIV reverse transcriptase, a mutant form of T7 phage DNA polymerase that lacks 3′-5′ exonuclease activity, or a mixture thereof. In a specific embodiment, the strand-displacing polymerase is Klenow or is the mutant form of T7 phage DNA polymerase that lacks 3′→5′ exonuclease activity.

Methods utilized herein may further comprise subjecting single stranded nucleic acid molecule/primer mixtures to a polymerase-processivity enhancing compound, such as, for example, single-stranded DNA binding protein or helicase.

In another aspect of the present invention, there is a method of amplifying a genome comprising obtaining genomic DNA; modifying the genomic DNA to generate at least one single stranded nucleic acid molecule; subjecting said single stranded nucleic acid molecule to a plurality of primers to form a nucleic acid/primer mixture, wherein the primers comprise nucleic acid sequence that is substantially non-self-complementary and substantially non-complementary to other primers in the plurality, wherein said sequence comprises in a 5′ to 3 ′ orientation a constant region and a variable region; subjecting said nucleic acid/primer mixture to a strand-displacing polymerase, under conditions wherein said subjecting steps generate a plurality of DNA molecules comprising the constant region at each end; and amplifying a plurality of the DNA molecules through polymerase chain reaction, said reaction utilizing a primer complementary to the constant nucleic acid sequence.

The method may further comprise the steps of modifying double stranded DNA molecules to produce single stranded molecules, said single stranded molecules comprising the known nucleic acid sequence at both the 5′ and 3′ ends; hybridizing a region of at least one of the single stranded DNA molecules to a complementary region in the 3′ end of an oligonucleotide immobilized to a support to produce a single stranded DNA/oligonucleotide hybrid; and extending the 3 ′ end of the oligonucleotide to produce an extended polynucleotide. In specific embodiments, the method further comprises the step of removing the single stranded DNA molecule from the single stranded DNA/oligonucleotide hybrid.

In another aspect of the present invention, there is a kit comprising a plurality of polynucleotides, wherein the polynucleotides comprise nucleic acid sequence that is substantially non-self-complementary and substantially non-complementary to other polynucleotides in the plurality, said plurality dispersed in a suitable container. The kit may further comprise a polymerase, such as a strand displacing polymerase, including, for example, Φ29 Polymerase, Bst Polymerase, Vent Polymerase, 9° Nm Polymerase, Klenow fragment of DNA Polymerase I, MMLV Reverse Transcriptase, a mutant form of T7 phage DNA polymerase that lacks 3′-5′ exonuclease activity, or a mixture thereof.

In an additional aspect of the invention, there is a method of amplifying a population of DNA molecules comprised in a plurality of populations of DNA molecules, said method comprising the steps of obtaining a plurality of populations of DNA molecules, wherein at least one population in said plurality comprises DNA molecules having in a 5′ to 3 ′ orientation a known identification sequence specific for the population and a known primer amplification sequence; and amplifying the population of DNA molecules by polymerase chain reaction, the reaction utilizing a primer for the identification sequence.

Certain embodiments of the methods have been commercialized. For example, Sigma (a division of Sigma-Aldrich Corporation) has recently launched a new whole genome amplification kit, GenomePlex™ Whole Genome Amplification (Product code WGA-1) and OmniPlex™ Whole Genome Amplification kit, which are based on Rubicon Genomics's proprietary GenomePlex WGA technology. The GenomePlex™ Whole Genome Amplification (WGA) kit utilizes the proprietary amplification method designed for robust and accurate amplification of limited source DNA. In less than three hours, GenomePlex™ WGA successfully amplifies nanogram amounts of starting DNA, regardless of source, into microgram yields. The new GenomePlex WGA kit may be used with Sigma's JumpStart™ Taq DNA Polymerase (Product code D9307).

Advantages of GenomePlex WGA include:
Flexibility to study DNA from any source;
No detectable locus or allele bias;
Compatibility with a variety of microarray, capillary, and homogenous platforms;
for sequencing, genotyping, CGH, FISH, ChIP, forensics, and biosurveillance;
Increased sensitivity and accuracy for population studies, mutation discovery, and pharmacogenomics; and
Robust amplification of problematic and highly degraded DNA from formalin-fixed, serum, buccal swab, archived, forensic and environmental samples

Other commercial WGA kits include REPLI-g Kit from QIAGEN Inc. (Valencia, Calif.); and GenomiPhi™ DNA Amplification Kit from Amersham Biosciences (Piscataway, N.J.), etc.

### VI. Prostate Cancer Ideograms

The instant invention also provides a list of genomic abberations observed in prostate cancer patients. Such information can be used to focus research, diagnosis, and prognosis analysis efforts on relatively small, yet highly risky areas of the chromosomes, and can be used to aid cluster analysis of mutation—disease correlation.

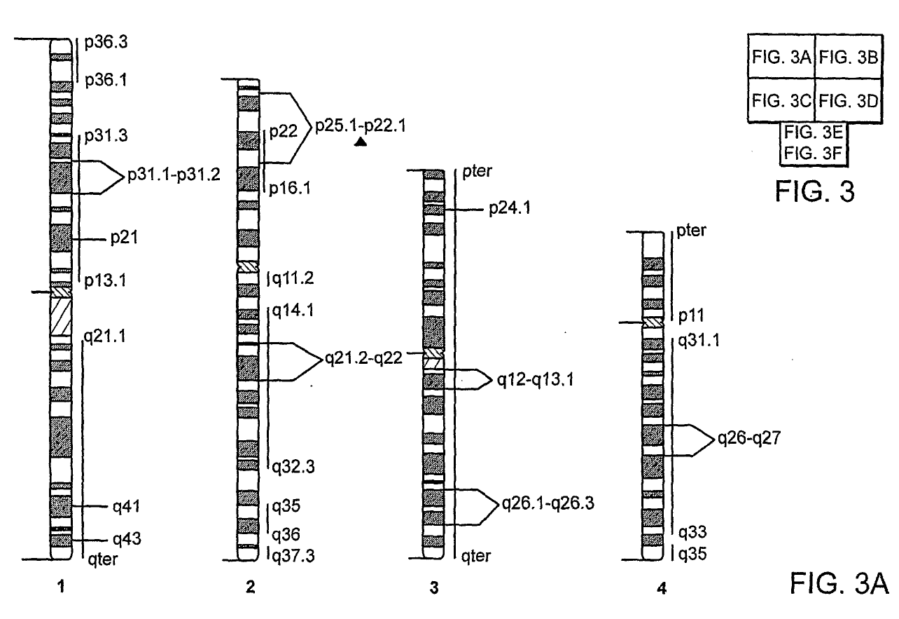

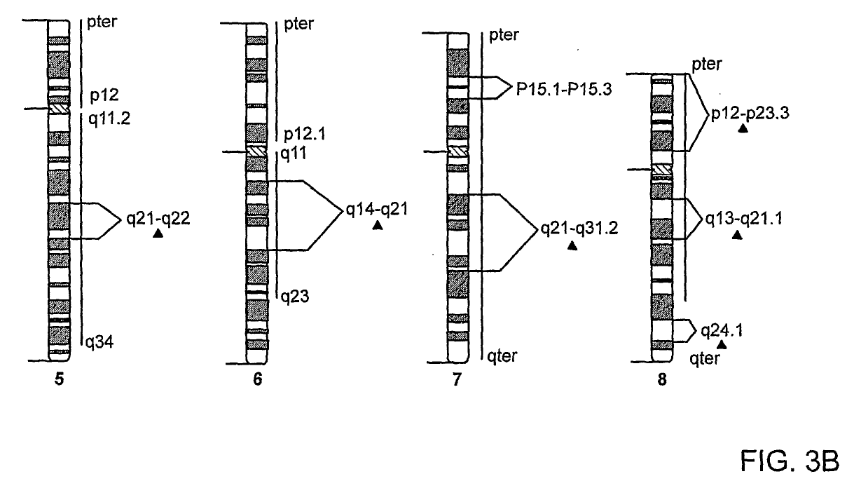

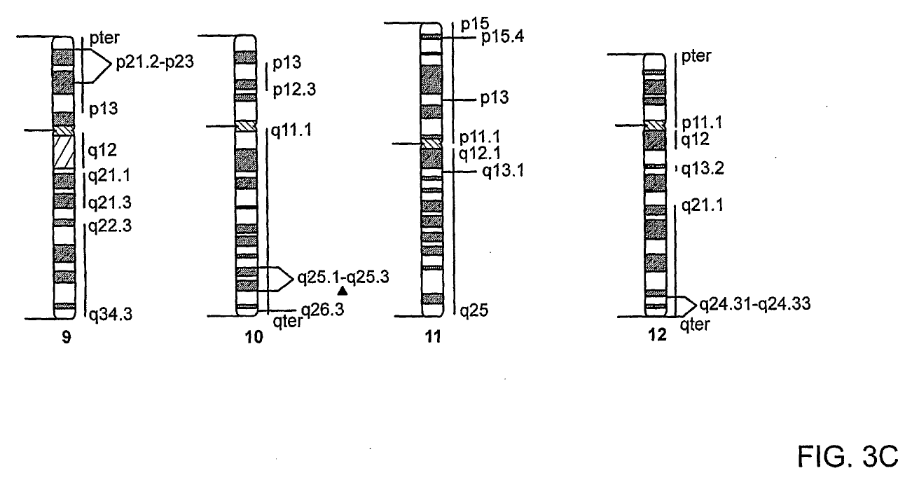

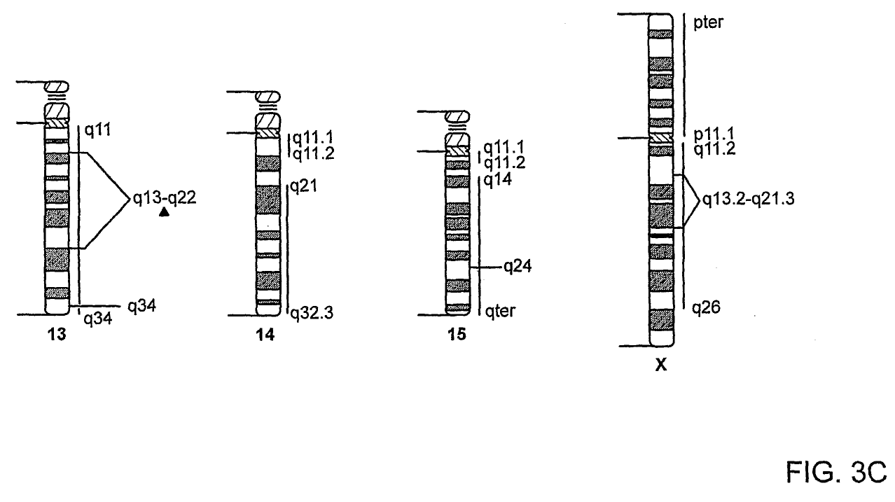

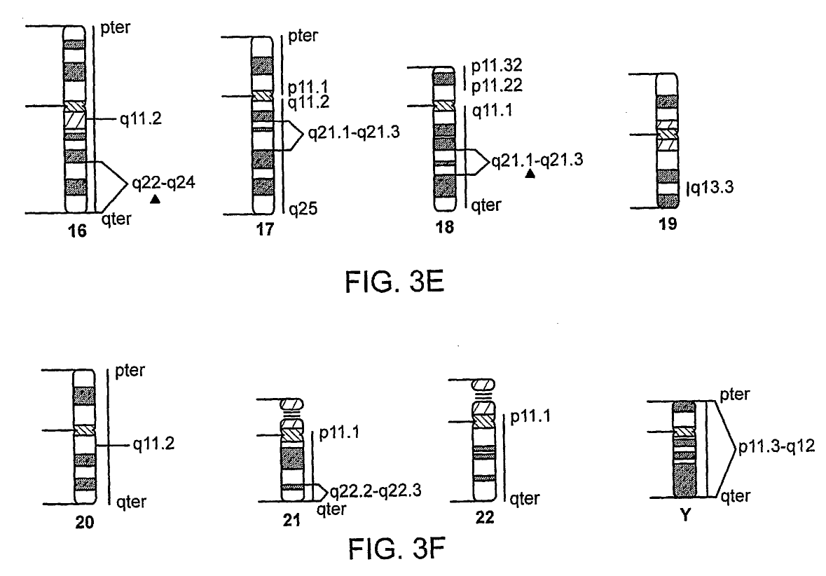

To compile such a list of genomic abberations, publications starting from 1992 up to date were exhaustively reviewed to identify all regions of deletions and gains, which were then combined into one large ideogram. See FIG. 3. All reported regions of loss or gain are noted in black. It is apparent that all chromosomes were affected in one aspect or another.

Further analysis minimized the prominent regions of interest (“Prominent Minimal Region of Interest,” or PMRI). Such regions are shown as marked horizontal bars beside each chromosome. A single line represents one particular band. A line created into an arrow represents more than one band of involvement. The regions/bars marked with a triangle under the banding region are observed to contain abberations in high occurrence, which exceeds approximately fifty or more cases. Such regions are preferred for the assays/devices of the invention. The p arm of chromosome eight and the q arm of chromosome 13 showing the most common aberrations, ranging from 150-250 or more cases. These PMRI regions can be selectively chosen to be used in genomic microarrays for high resolution screening of patient samples.

### EXAMPLE

This invention is further illustrated by the following examples which should not be construed as limiting. Reasonable variations and/or modifications of the protocols by a skilled artisan may be used for different experiments, which variations and modifications are within the scope of the instant invention. The contents of all references, patents and published patent applications cited throughout this application, as well as the Figures are hereby incorporated by reference.

Since numerous changes within the genomes of cancer patients have been reported, it would be helpful if a technology existed which could use a small amount of disease sample, such as prostate cancer tissue, and examine the entire genome with sufficient resolution to identify the common areas of aberration. Comparative genomic hybridization (CGH) is a well-established technique for surveying the entire genome for abnormalities (Kallionemi, 1992). However, standard CGH has relatively low resolution and has been used primarily on cell lines and in homogenous populations (sources). Genomic microarray (GM) provides a much higher-resolution analysis of chromosomal DNA gains/losses, but its potential for studying solid tumor specimens is tempered by concerns about the inherent heterogeneity of such a specimen. This is particularly the case in prostate cancer—a problem with cytogenetic prostate cancer analysis has been the study of the appropriate cell types, since this is a highly heterogeneous tumor. Therefore, work is needed to elucidate the ability and accuracy of this technology to detect chromosomal abnormalities in heterogeneous populations. In this study, GM is used to analyze prostate tumor tissue for gain and/or loss of chromosomal DNA and to determine the correlation between these changes and clinical outcome.

Specifically, GM was performed using the Spectral Genomics Inc. dye reversal platform on twenty primary prostate tumors, which were fresh frozen over the last twelve years. Multiple clinical parameters, including follow-up were collected from patients from which these samples were obtained. Further, cytogenetic analysis was previously attempted on all samples. Eighty percent (16/20) of specimens showed copy number changes, 65% of which were losses and 35% were gains of genetic material. The most common change observed were loss of an interstitial region of 2q (8 cases each, 40%), followed by loss of interstitial 6q (6 cases, 30%), loss at 13q, and loss at 8p, 16q and Xq (4 cases each, 20%). There was evidence of correlation of loss at 5q with a positive node status. Cytogenetic studies on these same patients detected clonal changes in only 40% (8/20) of specimens and did not detect the majority of abnormalities seen by the GM technique. Thus this technology is suitable for the evaluation of prostate and other heterogeneous cancers as a rapid and efficient way to detect genetic copy number changes, and their association/correlation with specific clinical outcomes.

### Introduction

Since the inception of prostatic specific antigen (PSA) screening in the United States, the incidence of prostate cancer diagnosis has increased and a trend toward lower grade and lower stage tumors has been observed (1, 2). These lower stage and grade tumors tend to be more indolent, raising concern about over-treatment of these patients. There are no reliable clinical prognosticators defining which tumors will progress after a defined treatment for localized prostate cancer. Consequently, there is a growing need to develop new tools to discern which patients are truly at increased risk for aggressive disease and who require therapy.

Despite the large volume of genetic data on prostate tumor biology, no consistent genetic defect has been identified for predicting clinical outcome. Various chromosomal abnormalities have been described in prostate cancer. Among the most common reported are trisomy and hyperdiploidy (3), gains of 6p, 7q, 8q, 9q, 16q (4-7), deletions of 3q, 6q, 8p, 10q, 13q, 16q, 17p, 20q (4, 8, 9), and aneusomy of chromosomes 7 and 17 (3). Many reports have suggested clinical statistical significance with these common changes. Van Dekken and colleagues found that gain at 8q was independently associated with disease progression even after considering tumor grade and stage, margin status, and preoperative PSA (4). Loss of heterozygosities (LOHs) at 13q14 and 13q21 were reported to be more common in tumors associated with local symptoms (10). Loss at 16q in combination with loss at 8p22 has been associated with metastatic prostate cancer (11). Several groups have reported that the number of genetic abnormalities seen correlates with worse prognosis (4, 12). Although trends from these studies have certainly emerged, chromosomal findings have varied substantially among series, and clinical correlations are suboptimal due to insufficient power.

A confounding problem with previous studies has been the large amount of cellular heterogeneity in prostate tissue. Due to the nature of prostate tumor tissue, there are no reliable methods to select only for tumor cell outgrowth for cytogenetic studies. This has led to a high frequency of normal karyotypic findings reported (7).

Comparative genomic hybridization (CGH) is a well-established technique for surveying the entire genome for abnormalities (13). CGH microarray (“Genomic Microarray”, GM) was introduced as a sensitive method for detecting genomic imbalances using arrayed clones on a glass slide (14, 15). This technology has recently shown promise in the analysis of fixed prostate tumors following tissue dissection (4, 16, 17). The question still remains as to whether this technique is sensitive enough to detect chromosomal abnormalities using whole tissue with known cellular heterogeneity. Dye reversal GM is used herein to analyze grossly dissected fresh frozen prostate tumor tissue for gain and/or loss of chromosomal DNA and to determine correlation existing between these changes and clinical outcome.

### Methods and Materials

Patient selection: The University of Utah Institutional Review Board approved all analyses of patient specimens. Between 1992 and 2001, tissue was collected from 230 patients undergoing radical prostatectomy and processed for cytogenetic and molecular evaluation at our institution. Clinical information about these patients including age, pathologic Gleason score, pathologic stage, preoperative PSA, lymph node status, and follow up time was entered into a Microsoft Access database. A total of 20 patients were selected from this database Ten of these patients were randomly selected; an additional 5 patients with and 5 patients without biochemical recurrence were also selected for GM analysis. The investigators were blinded to all clinical information after patient selection.

Tissue Processing: Each patient signed a statement of informed consent prior to tissue collection. At surgery, frozen section histology was performed on the prostate to determine and map cancerous and benign areas. Fresh tissue samples adjacent to all histologically mapped areas (benign and malignant) were submitted to our tissue bank. Specimens were flash frozen in liquid nitrogen and stored in cryo vials in the −130° C. freezer until use.

Touch Preparation: Touch preparation slides were made by touching each histologically-known tissue sample to a cold, wet microscope slide and then placing the slides in 100% ethanol overnight. Slides were stored at −20° C. until use for fluorescence in situ hybridization (FISH).

Direct fluorescence in situ hybridization (FISH) cells: FISH cell suspensions were prepared from tissue adjacent to each frozen section site as previously described (18). Briefly, the tissue was mechanically digested, and then swollen with 0.075 M KCl and fixed with 3:1 methanol:glacial acetic acid fixative. Cells were dropped onto cold, wet microscope slides and stored at −20° C.

DNA Extraction: Tissue was removed from the −130° C. freezer and transferred to a centrifuge tube containing 300 μL of PureGene (Minneapolis, Minn.) protein lysis solution and 2.5 μl Proteinase K (20 mg/ml). The specimen was crushed and placed in a 55° C. water bath overnight. 2.5 μL of RNAse A (4 mg/ml) was added to the lysate and incubated at 37° C. for 1 hour. After cooling the lysate to room temperature, 100 μL of PureGene protein precipitation solution was added, and the lysate was centrifuged. The supernatant was transferred to a new tube, and 300 μL of 100% isopropanol was added. After centrifugation, the supernatant was discarded and the DNA pellet was washed with 300 μL of 70% ethanol. The pellet was dried and rehydrated by normal standards. DNA purity was verified by agarose gel electrophoresis, and DNA concentrations were measured with fluorometry.

FISH Probes: FISH probes were chosen to confirm abnormal sites detected by GM. Probes labeled with spectral orange for c-MYC (8q24.12-24.13), 9q subtel, ATM (11q22.3), Rb-1 (13q14), 16q subtel, and 21q subtel were purchased from Vysis Inc. (Downers Grove, Ill.). For all other changes, bacterial artificial chromosome (BAC) probes identified from the GM ratio plots were purchased from Spectral Genomics (Houston, Tex.). These BACs were biotinylated using the Gibco BioNick labeling system (Life Technologies Inc, Gaithersburg, Md.) protocol then labeled with strepavidin/Cy3 and hybridized to lymphocyte metaphases to confirm their locations.

FISH: FISH was performed on specimens to confirm selected genetic changes which were detected in multiple patients. Protocols were as described by the manufacturer (Vysis) or as previously described for “home-brew” probes (19, 20). Each hybridization was performed on prostate cancer and normal prostate cells from the same patient using either direct FISH or touch-prep slides. Two observers each scored a minimum of 100 nuclei for every hybridization. Criteria for scoring gains and losses were previously reported (8, 19, 20). Briefly, gains were considered significant if more than 5% of cells had 3 signals while significant losses required greater than 8% to have only 1 signal.

Dye reversal GM: Prostate tissue was removed from the −130° C. freezer and DNA was prepared per PureGene (Minneapolis, Minn.) protocol. The final DNA purity was assessed by agarose gel electrophoresis, and DNA concentrations were measured with fluorometry. Genomic Microarray results from 20 prostate cancer specimens were compared with pooled GM data from 7 normal males. All microarrays were performed utilizing Spectral Genomics' (Houston, Tex.) 1 Mb Genomic Microarrays and 1 μg of high molecular weight, RNA-free genomic DNA from fixed tumor samples. Ultra-pure deionized H₂O was used for the preparation of all reagents; Puregene Male Genomic DNA (Gentra Systems Inc., Minneapolis, Minn.) was used as reference DNA; and dye-reversal experiments whereby two microarrays, each with reciprocal labeling of the test and reference DNAs, were performed for each sample. The test and reference DNAs were random-primed labeled by combining 1 μg gDNA (genomic DNA) and ddH₂O to a total volume of 50 μL and sonicating in an inverted cup horn sonicator to obtain fragments 600 bp to 10 kb in size. DNA cleanup was performed utilizing Zymo's Clean-up Kit (Orange, Calif.) according to protocol except final elution with two volumes of 26 μL ddH₂O. The elutant was split equally between two tubes and, to each, 20 μL 2.5× random primers from Invitrogen's (Carlsbad, Calif.) BioPrime DNA Labeling Kit was added, mixed well, boiled 5 min., and then immediately placed on ice 5 min. To each was added 0.5 μL Spectral Labeling Buffer (Spectral Genomics; Houston, TX), 1.5 μL Cy3-dCTP or 1.5 μL Cy5-dCTP respective to each dye reversal experiment (PA53021, PA55021 Amersham Pharmacia Biotech; Piscataway, N.J.), and 1 μL Klenow fragment (BioPrime DNA Labeling Kit). The contents were incubated for 1.5 hrs. at 37° C. before stopping the labeling reaction by adding 5 μL 0.5 M EDTA pH 8.0 and incubating 10 min. at 72° C.

For hybridization to the array, the Cy3-labeled test DNA and Cy5-labeled reference DNA and, conversely, the Cy5-labeled test DNA and Cy3-labeled reference DNA were combined. 45 μL human Cot-1 DNA (Invitrogen), 11.3 μL 5 M NaCl, and 110 μL room temperature isopropanol were added, mixed, and allowed to sit 15 min. before centrifugation at 13 krpm for 15 min. The pellet was washed with 500 μL 70% EtOH and allowed to air dry 10 min. Onto each pellet 50 μL hybridization solution (50% Deionized Formamide, 10% Dextran Sulfate, 2×SSC, 2% SDS, 6.6 μg/mL Yeast tRNA in Ultrapure H₂O) was added and allowed to sit 10 min. before repeat pipetting to fully re-suspend. The probes were denatured by incubation for 10 min. at 72° C., then immediately place on ice 5 min. Samples were incubated at 37° C. for 30 min. before pipetting down the center length of a 22×60 mm cover slip and placing in contact with a microarray slide. Each slide was enclosed in an incubation chamber and incubated, rocking, at 37° C. for >16 hrs.

Post-hybridization washes were performed with each slide in individual deep Petri dishes in a rocking incubator. After removing the coverslip, the slides were briefly soaked in 0.5% SDS at room temperature. Each slide was then transferred quickly to 2×SSC, 50% deionized Formamide pH 7.5 for 20 min.; then 2×SSC, 0.1% IGEPAL CA-630 pH 7.5 for 20 min.; then 0.2×SSC pH 7.5 for 10 min., each pre-warmed to 50° C. and agitated in an incubator at 50° C. Finally, each slide was briefly rinsed in two baths of room temperature ddH₂O and immediately blown dry with compressed N₂ and scanned. Scanning was performed with Axon's GenePix 4000B microarray scanner and the images were analyzed with SpectralWare 2.0 (Spectral Genomics Inc.; Houston, Tex.) for preparation of ratio plots.

Image Data Analysis. The human BAC clones spotted onto glass slides were obtained from Spectral Genomics Inc. (Houston, Tex.), prepared using a printer with a print head with tips in a 12×1 configuration. The fluorescence intensity ratios for spots on the slide were grouped by print tip, and were spatially normalized by subtracting the print tip group median intensity ratio from each spot's intensity ratio; prior to this spatial normalization, some slides may show certain degrees of spatial bias (21). Spots with low signal-to-noise (background) ratios were excluded. The mean intensity ratio for each clone was calculated from up to four remaining values (each clone was spotted twice on a slide, and the experiment was run in a dye-swap configuration). This provided control for potential Cy3/Cy5 induced labeling bias. The chromosome with minimum variance in clone intensity ratios was chosen as a “control chromosome”. A 99% confidence interval was calculated using the intensity ratios from this chromosome, and all clones were classified using this confidence interval; clones with intensity ratios above this interval were considered amplified, and beneath this interval were considered deleted. This method, when applied to samples with known abnormalities, provided correct classifications for 98.8% of normal clones, and 97.9% of amplified or deleted clones. The statistical significance of runs of consecutive amplified or deleted clones was measured using the scan statistic (22).

GM analysis: For the purpose of this study, single BAC changes were not considered. We employed our statistical algorithm to identify genomic regions containing gains or losses. From this analysis, we generated a list of BACs involved in each gain and loss. For each change, the flanking BAC names were recorded and mapped using the National Cancer Institute's BAC map web-based database (http://www.ncbi.nlm.nih.gov/genome/cyto/hbrc.shtml). To determine how well experienced observers could interpret the ratio plots, we defined criteria for change, such that any deviation of the ratio curves from 1.0, sustained over 3 consecutive BACs was considered to be a real change, since this is never seen on the control plots. The changes detected by human observers were compared with those detected by the statistical algorithm. Concordance between the observer and computer generated changes was defined as having overlap in the reported changes in the two groups.

Statistics: All chromosomal changes that were seen in at least 2 patients were put into a univariate model to determine correlation with patient age, pre-operative PSA, pathologic Gleason score, pathologic stage, and PSA recurrence. A multivariate model was then constructed incorporating only the statistically significant chromosomal changes as well as Gleason score, pathologic stage, and preoperative PSA to analyze factors contributing to PSA progression.

### Results

Clinical characteristics of the patients and a summary of statistically significant GM findings are listed in Table 1 and 2, respectively, where “UCAP” (Utah Cancer of Prostate) represents individual patients. The median age of patients was 63.5 years (range 47-77 yrs). Preoperative PSA (median) was 7.1 ng/ml (range 2.8-30.7) and Gleason scores ranged from 4-9. The median follow-up after surgery was 64 months.

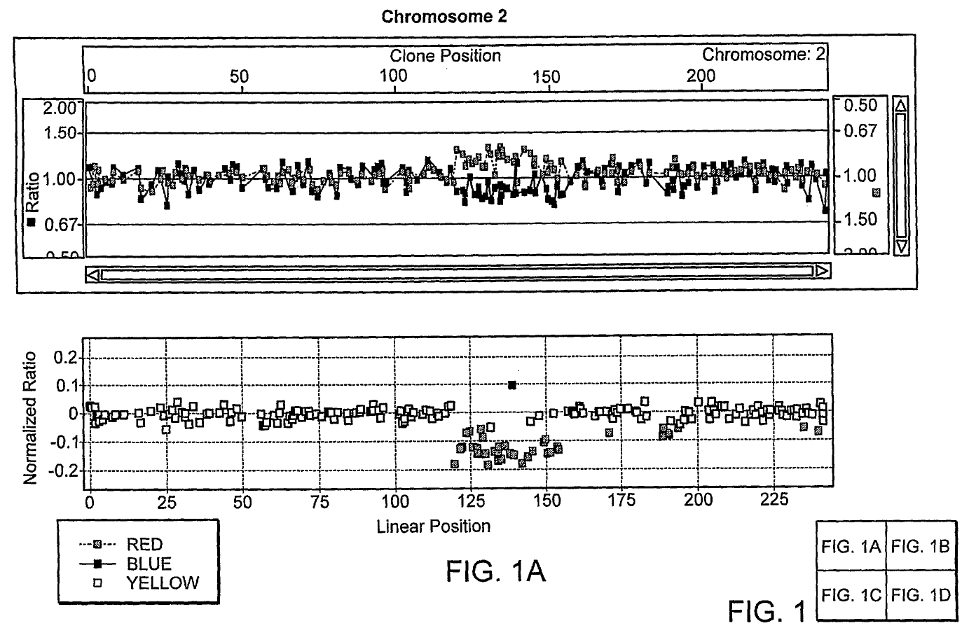

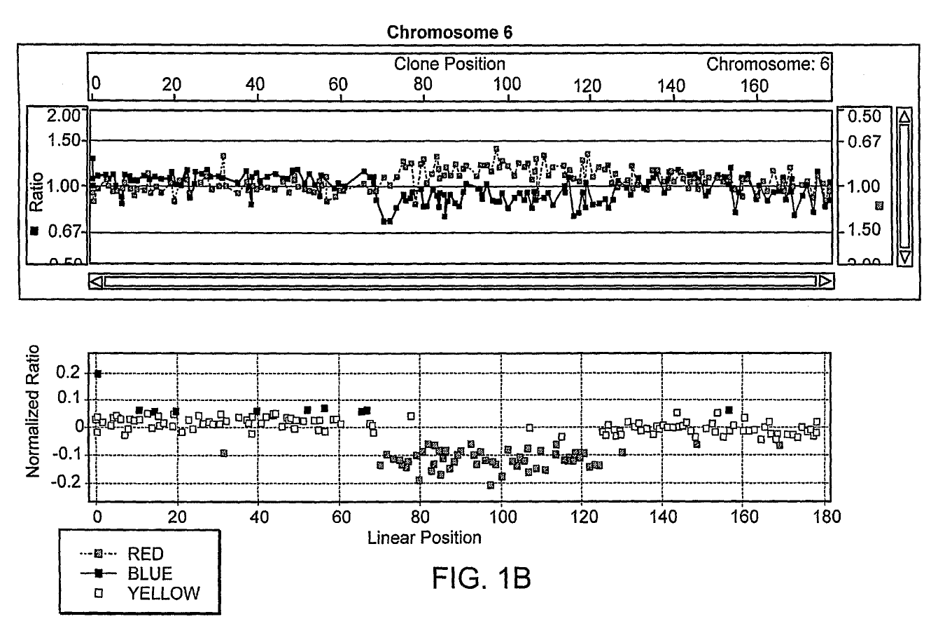

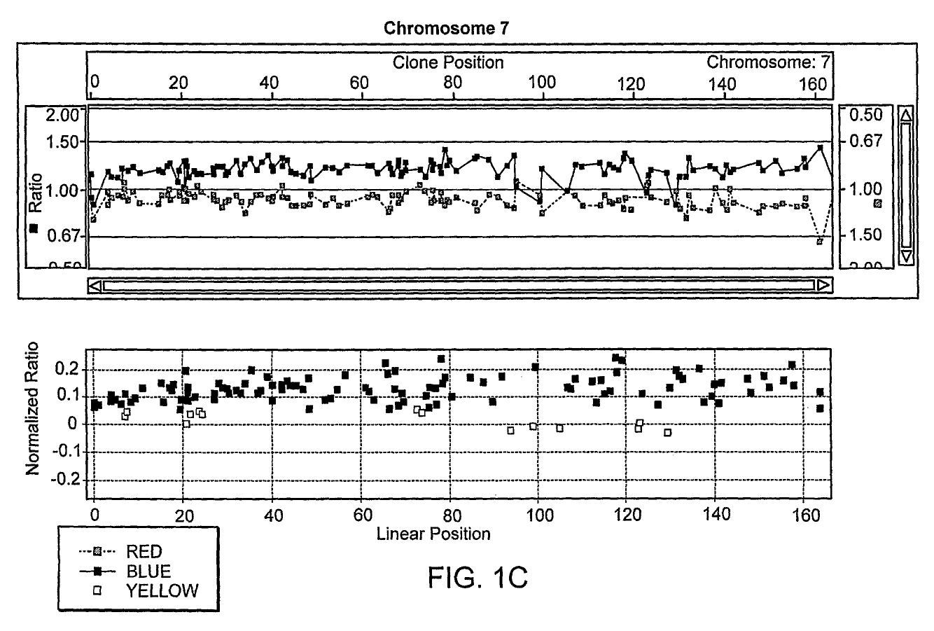

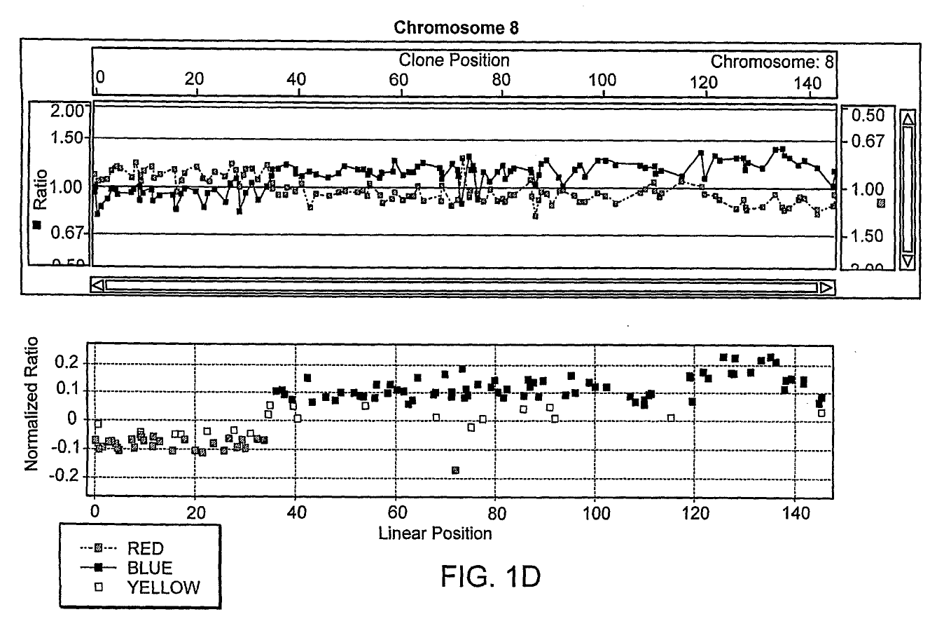

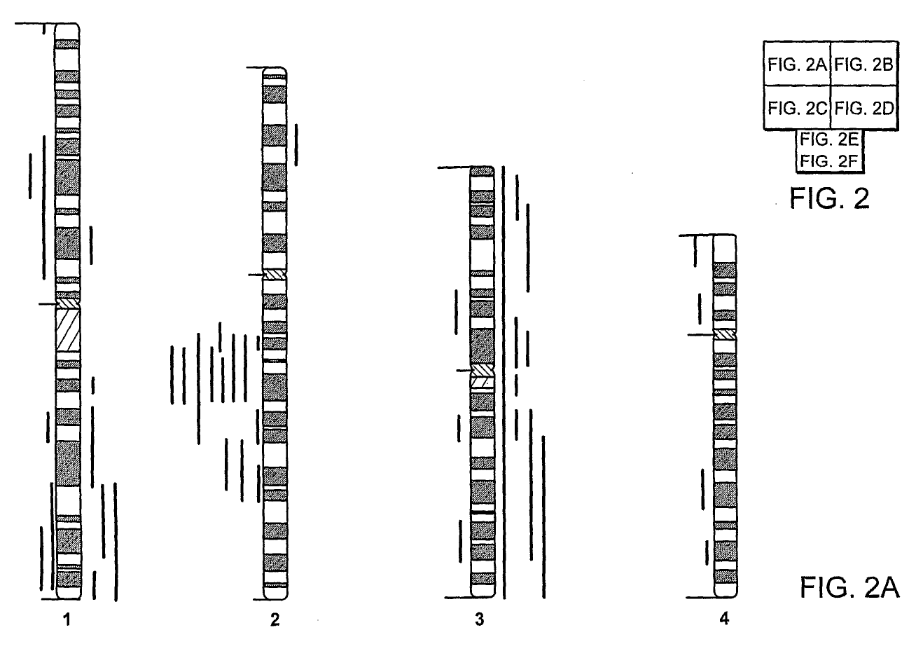

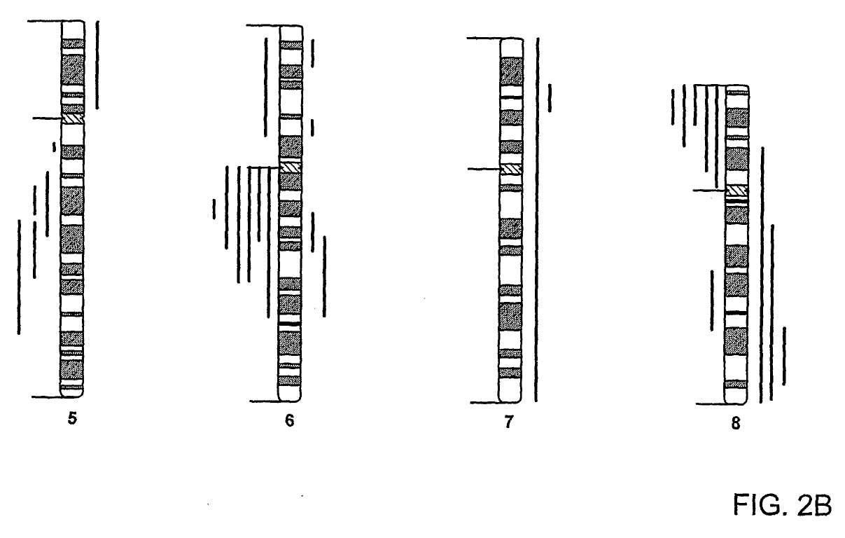

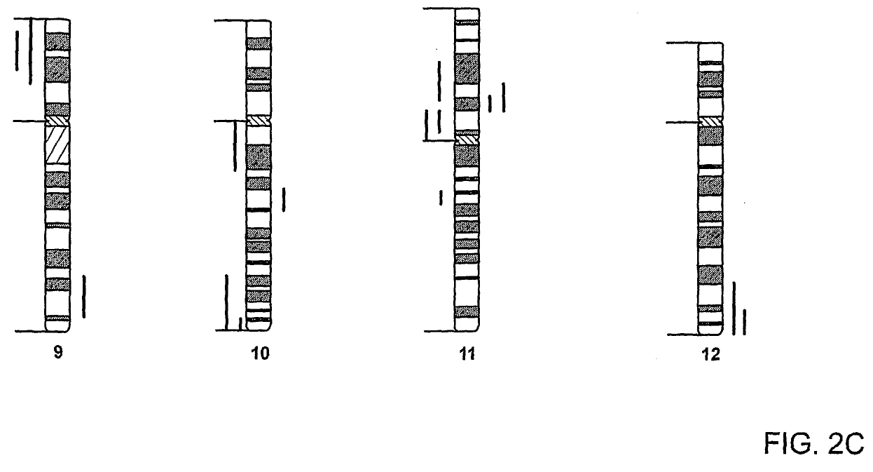

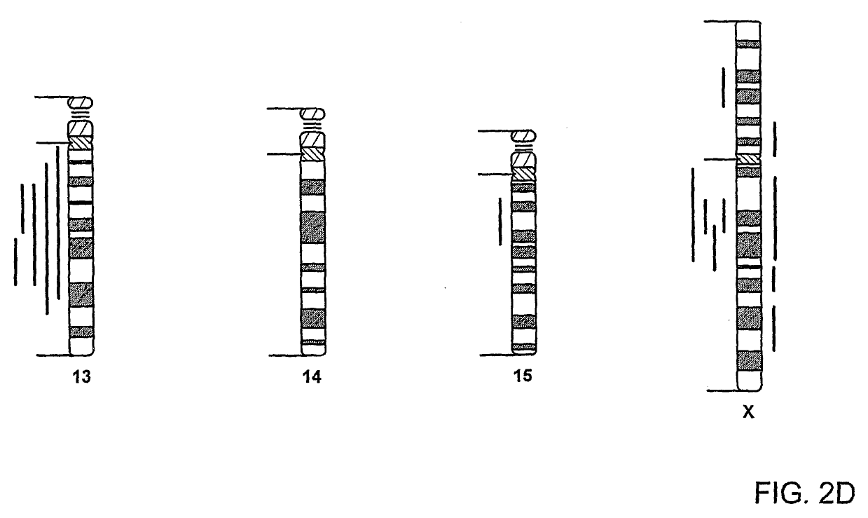

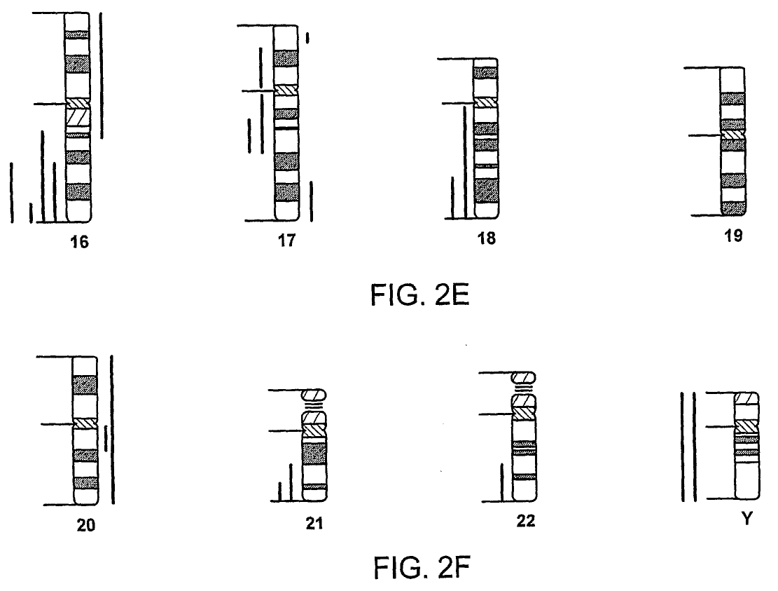

Representative examples of GM ratio plots and statistical scatter plots for four chromosomes for one patient (UCAP 27) are shown in FIG. 1. A power of the Spectral Genomics platform is the use of dye reversal, with results displayed in the upper plot for each chromosome. Divergence of each line from a ratio of 1 in those plots signifies either gain or loss of fluorescence intensity at each linear clone. By convention, when the software depicts a concurrent red line above and blue line below 1.0, this signifies loss at that site. Conversely, a concurrent blue line above and red line below 1.0 signifies gain. For the lower scatter plot for each chromosome, statistically significant loss or gain is represented by red or blue dots, respectively, at each clone; no significant change is shown as a yellow dot. All chromosomes for all specimens were analyzed in this manner, resulting in the summaries shown in Table 2. A summary ideogram is given in FIG. 2, showing all statistically significant changes detected by GM.

Various abnormalities detected by GM were “spot” checked by performing FISH on primary tumor cells. There was complete concordance using this validation procedure; the cases examined are indicated in Table 2. Table 2 also shows clonal changes detected by cytogenetic evaluation (previous studies in this laboratory) for those patients on which karyotypes could be obtained.

The total of 117 chromosome changes detected by GM in the twenty specimens are shown in Table 2. Of these, 76 were losses in copy number and 41 were gains. Eighty percent of the cases (16/20) showed some abnormality. The most common changes observed were loss of an interstitial region of 2q (8 cases each, 40%), followed by loss of interstitial 6q (6 cases, 30%), loss at 13q (5 cases, 25%), loss at 8p, 16q and Xq (4 cases each, 20%) and gain at 3p, loss at 5q and gain at 8p (3 cases each, 15%). As can be seen from Table 1, the patient with the most number of genetic changes observed (UCAP 27, 24 changes) also had a high Gleason score (8), positive margins and nodes, and experienced biochemical failure 9.2 months following surgery. Although the total number of cases studied limited the power of analysis, using a Fisher's exact test (23) without Bonferroni correction was able to provide a preliminary clinical correlation (a p value was set at <0.05) with loss at 5q associated with a positive node status (p=0.049).

TABLE 1
Patient Characteristics

| | | |
|---|---|---|
| Median Age | 63.5 | 47-77 |
| Median Preoperative PSA (ng/ml) | 7.1 | 2.8-30.7 |
| Median Follow Up (months) | 64.05 | 25.6-114 |
| Median Gleason Score | 6 | 4-9 |
| Path Stage | | |
| pT2 | 7 | 35% |
| pT3a | 7 | 35% |
| pT3b | 6 | 30% |
| | 5 | 25% |

Margin Positive

| | | |
|---|---|---|
| Node Positive | 8 | 40% |
| Biochemical Failure | 6 | 30% |

TABLE 2
GM-CGH Results
UCAP Clinical Data and Genetic Changes

| | | Preop | Path | | | | | Time to | Follow | Clonal | |
|---|---|---|---|---|---|---|---|---|---|---|---|
| | | PSA | Gleason | Path | Margin | Node | Disease | Failure | up | Cytogenetic | |
| UCAP | Age | (ng/ml) | Score | Stage | Status | Status | Status | (months) | (months) | Changes | GM Changes |
| 24 | 62 | 21 | 7 | pT3a | Negative | Negative | NED | | 66.8 | add (9)(p24), | Gain 1p21-1p21 |
| | | | | | | | | | | del (8)(p21), | Loss 8p11.2-8pter |
| | | | | | | | | | | del (16)(q22)[1] | Loss 16q22-16q24 |
| | | | | | | | | | | | Loss 17q21.1-17q21.3* |
| | | | | | | | | | | | Loss 21q22.1-21q22.3 |
| 25 | 70 | 30.7 | 7 | pT3a | Positive | Positive | Failed | 9.9 | 78.2 | −7, −9, | Loss 1p13.3-1p31.3 |
| | | | | | | | | | | del(10)(q24), | Loss 1q32-1q43 |
| | | | | | | | | | | del(5)(q15, q31)[1] | Loss 2q24-2q24 |
| | | | | | | | | | | | Loss 4p13-4p14 |
| | | | | | | | | | | | Loss 4q27-4q28 |
| | | | | | | | | | | | Loss 4q32-4q32 |
| | | | | | | | | | | | Loss 5q13.2-5q21.2 |
| | | | | | | | | | | | Loss 6p22.1-6p24 |
| | | | | | | | | | | | Loss 11q13.4-11q13.5 |
| | | | | | | | | | | | Loss 13q12-13q31.1 |
| | | | | | | | | | | | Loss Xp21-Xp21 |
| | | | | | | | | | | | Gain Xq25-Xq26.3 |
| 27 | 74 | 24.3 | 8 | pT3b | Positive | Positive | Failed | 9.2 | 71.9 | del(10)(q25) | Gain 1q22-1q22 |
| | | | | | | | | | | | Gain 1q24-1q31 |
| | | | | | | | | | | | Gain 1q32.1-1q41 |
| | | | | | | | | | | | Loss 1q41-1q43 |
| | | | | | | | | | | | Gain 1q43-1q44 |
| | | | | | | | | | | | Loss 2q14.2-2q24.1 |
| | | | | | | | | | | | Loss 2q32-2q32 |
| | | | | | | | | | | | Gain whole chrom. 3 |
| | | | | | | | | | | | Loss 5q21-5q23.1 |
| | | | | | | | | | | | Gain 6p23-6p24 |
| | | | | | | | | | | | Loss 4p16.1-4p16.3 |
| | | | | | | | | | | | Gain 6q15-6q16 |
| 57 | 57 | 1.9 | 6 | pT2 | Negative | Negative | NED | | 75.9 | No abnormal | Loss 2q21-2q22 |
| | | | | | | | | | | clones | Loss 2q31-2q32 |
| | | | | | | | | | | | Gain 6q16.3-6q22.3 |
| | | | | | | | | | | | Loss 8p21-8p23 |
| | | | | | | | | | | | Gain 8q13.2-8qter* |
| | | | | | | | | | | | Loss 10q25.1-10q26.3 |
| | | | | | | | | | | | Loss 16q24-16q24* |
| | | | | | | | | | | | Loss 17q11.2-17q21* |
| | | | | | | | | | | | Loss 18q11.2-18q23 |
| | | | | | | | | | | | Loss whole chrom. Y |
| 77 | 68 | 9.0 | 5 | pT2 | Negative | Negative | NED | | 86.2 | No abnormal | Loss 1p31-1p32.1 |
| | | | | | | | | | | clones | Gain 11p12-11p12 |
| 106 | 58 | 7.0 | 6 | pT2 | Negative | Negative | NED | | 74.0 | Hyperdiploid | Gain 2p21-2p22 |
| | | | | | | | | | | | Loss 2q14.3-2q22 |
| | | | | | | | | | | | Loss 3q13.3-3q13.3 |
| | | | | | | | | | | | Loss 6q12-6q21 |
| | | | | | | | | | | | Gain 11p12-11p13 |
| | | | | | | | | | | | Gain 12q24-12q24 |
| | | | | | | | | | | | Loss 13q21.3-13q22* |
| | | | | | | | | | | | Gain 17p13.2-17p13.3 |
| | | | | | | | | | | | Gain 17q24-17q25 |
| | | | | | | | | | | | Gain 20q11.1-20q11.2 |
| 127 | 61 | 12.1 | 9 | missing | Negative | Positive | NED | | 80.2 | −Y, −7 | Loss 6q14.1-6q14.3 |
| | | | | | | | | | | | Loss 8q21.3-8q22 |
| | | | | | | | | | | | Loss 9p21-9p24.3 |
| 128 | 52 | 6.7 | 7 | pT2 | | | NED | | 38.1 | del(6)(q23) | Normal |
| 143 | 72 | 5.3 | 7 | pT3a | Positive | Positive | Failed | 52.9 | 53.4 | No abnormal | Gain 1q32.1-1qter |
| | | | | | | | | | | clones | Gain 3p21.2-3p22 |
| | | | | | | | | | | | Gain 3q13.2-3q13.3 |
| | | | | | | | | | | | Gain 3q21-3qter |
| | | | | | | | | | | | Loss 6q12-6q21 |
| | | | | | | | | | | | Loss 8pter-8p23 |
| | | | | | | | | | | | Gain 8q23.3-8q24.1 |
| | | | | | | | | | | | Gain 12q24.3-12q24.3 |
| | | | | | | | | | | | Loss 18q22.1-18q23 |
| 149 | 63 | 14.7 | 9 | pT3a | Negative | Positive | NED | | 61.3 | No abnormal | Loss 2q14.3-2q14.3 |
| | | | | | | | | | | clones | Loss 2q31-2q32.1 |
| | | | | | | | | | | | Loss 3p13-3p14 |
| | | | | | | | | | | | Loss 5q14-5q14 |
| | | | | | | | | | | | Loss 5q21-5q31 |
| | | | | | | | | | | | Loss 6q12-6q16.2 |
| | | | | | | | | | | | Loss 9p21.3-9p23 |
| | | | | | | | | | | | Loss 11p11.2-11p12 |
| | | | | | | | | | | | Loss 13q14-13q31.1* |
| | | | | | | | | | | | Loss 16q22-16q24.1 |
| | | | | | | | | | | | Loss 17p11.1-17p12 |
| 161 | 77 | 5.0 | 6 | pT3b | Negative | Negative | NED | | 45.2 | −19 | Normal |
| 163 | 63 | 5.9 | 5 | | Negative | Negative | LTF | | 0 | inv (7)(p15p22) | Loss 22q13.1-22q13.3 |
| | | | | | | | | | | | Loss Xq13.3-Xq21.2 |
| 179 | 47 | 5.2 | 9 | pT3b | Negative | Positive | Failed | 1.5 | 34.4 | No abnormal | Normal |
| | | | | | | | | | | clones | |
| 205 | 68 | 15 | 5 | pT3b | Positive | Negative | NED | | 50.6 | No abnormal | Loss 2q14.3-2q22 |
| | | | | | | | | | | clones | Loss 3q26-3q26 |
| | | | | | | | | | | | Gain 7p15-7p15 |
| | | | | | | | | | | | Gain Xp11.1-Xp11.2 |
| | | | | | | | | | | | Gain Xq13-Xq21 |
| | | | | | | | | | | | Gain Xq22.3-Xq23 |
| 227 | 72 | 10.2 | 7 | pT3a | Negative | Positive | NED | | 25.6 | Not karyotyped | Loss 1q24.1-1q25.2 |
| | | | | | | | | | | | Loss 11p13-11p14.3 |
| | | | | | | | | | | | Loss Xq12-Xq21 |

*Microarray change confirmed by FISH;
NED = “no evidence of disease”

### Discussion:

Examples herein are the first demonstration of use of dye reversal GM to analyze surgically procured prostate cancer specimens. Recently, GM has been used for the analysis of prostate cancer cell lines (24), or microdissected prostate tumor tissue (16, 17), showing feasibility and high fidelity for the GM technique. Our technique employs a high-resolution microarray chip and two simultaneous hybridizations (dye reversal) to improve detection of genetic gains and losses. The statistical evaluation used offers strong support that changes detected, even in the heterogeneous prostate tissue, represent true clonal abnormalities.

Performing genomic analysis on solid tumors is difficult because of the relative paucity of actual tumor cells in the specimen relative to normal cells such as fibroblasts, inflammatory cells, and normal stromal cells. When DNA was extracted herein from a gross specimen, there was no effort to remove the normal DNA from the malignant tissue. Therefore, the normal DNA dilutes malignant changes in the tumor. The dilutional effect is dependent upon the method of tissue procurement and the volume of tumor within the specimen. Although histological mapping of benign and malignant areas adjacent to each sample was done, there is no definitive way of knowing how much of each specimen was actually tumor.

Analysis of gross tissue samples is preferable to analysis of cell lines, PCR, or microdissection because the time, costs, and labor of processing a direct sample are diminished. While concerns regarding the inherent heterogeneity of prostate cancer specimens are legitimate, we show herein that gains and losses can be identified using this technique. Because there is no standard for interpreting ratio plots from mixed samples, we utilized a statistical algorithm to distinguish actual change from simple noise. Furthermore, changes are readily observed due to the dye swap experiments employed by Spectral Genomics platform.

Although for the purpose of this particular study, changes detected herein at only a single BAC on the microarray were not further considered, since individual BACs may be mis-mapped or may represent polymorphisms or a technical artifact, it is entirely possible that single BAC changes could similarly fit a statistically valid model.

Our observation of loss at 2q being the most frequent differs from previous studies of prostate and other solid tumors (25). Other common findings observed (FIG. 2 and Table 2) herein including gains on 8q and losses on 6q, 8p, 10q, 13q, and 16q are consistent with other reports, and may have clinical correlation (26). Steiner et al found that gain of 8q was a common anomaly in prostate biopsy samples and that the gain was associated with progression to androgen resistant disease (5). Takahashi noted that gains of chromosome 8 and aneusomy of Y were independently associated with prostate cancer progression and cancer death (27). Van Dekken and colleagues reported that gains on distal 8q were independent predictors of disease progression whereas deletions on 6q, 8p, and 13q are not (4). The cMYC gene and prostate stem cell antigen are both found on 8q and have been shown to be over expressed in prostate cancer (28, 29). Deletion at 6q24 and loss of E-cadherin function have been reported as frequent findings in familial (30) and metastatic prostate cancer (31). Patients with deletions on both 8p22 and 16q24 have been reported to have higher potential for lymphatic involvement (11). Loss of 13q is also a common finding and has been associated with high grade or metastatic tumors (32). The Rb-1 gene is lost in approximately ⅓ of localized prostate cancer (33, 34). Another possible tumor suppressor gene on 13q is KLF5. Loss of 16q is a commonly reported finding in prostate cancer although its clinical importance is controversial. Cooney et al reported loss of heterozygosity at 6q in 33% but found no correlation of with pathologic stage or Gleason score in their series of 52 patients (35). However, Matsuyama reported that when combined with loss at 8p, loss at 16q was associated with metastatic disease (11).

GM greatly enhanced the karyotypic findings in most patients. We and others have questioned whether the appropriate cells were dividing in culture and thus analyzed in metaphase [7]. The power of GM appears not only to include high-resolution analysis of the genome but also sufficient sensitivity to detect abnormal clones in a heterogeneous population that were not detected by cytogenetic analysis of cultured cells. Two single cell changes seen by cytogenetics [del(1 6) and del(5) on UCAP 24 and UCAP 25, respectively] are noted in Table 1 as these are indicative of the larger population of abnormal cells, which was detected by GM. Of interest is the concordant finding of a deletion of 10q in UCAP 27 by both cytogenetics and GM. The cytogenetically defined deletion (10)(q25) is consistent with several previous reports of deletion at this site in prostate tumors (37), yet multiple clones were deleted as shown by GM at the more proximal band. The 2 distal dark bands on 10q could easily be confused, and the interstitial deletion defined by GM may be the more common deletion. Furthermore, none of the other changes observed by GM were detected by cytogenetics in this specimen, indicating the superior sensitivity of the GM technique.

The ease, power and reproducibility of GM make this a strong technology for the evaluation of tumor cells. A drawback of the technique is the inability to detect balanced chromosomal rearrangements, as it will only identify copy number changes. Most solid tumors have an unbalanced genome (38), minimizing the effect of this limitation. We suggest that GM will prove valuable in detecting abnormal populations in other heterogeneous cancers.

### REFERENCES

[1] Stephenson R A, Stanford J L. Population-based prostate cancer trends in the United States: patterns of change in the era of prostate-specific antigen. World J Urol 1997; 15: 331-5.
[2] Stephenson R A. Prostate cancer trends in the era of prostate-specific antigen. An update of incidence, mortality, and clinical factors from the SEER database. Urol Clin North Am 2002; 29: 173-81.
[3] Cui J, Deubler D A, Rohr L R, et al. Chromosome 7 abnormalities in prostate cancer detected by dual-color fluorescence in situ hybridization [In Process Citation]. Cancer Genet Cytogenet 1998; 107: 51-60.
[4] van Dekken H, Alers J C, Damen I A, et al. Genetic evaluation of localized prostate cancer in a cohort of forty patients: gain of distal 8q discriminates between progressors and nonprogressors. Lab Invest 2003; 83: 789-96.
[5] Steiner T, Junker K, Burkhardt F, et al. Gain in chromosome 8q correlates with early progression in hormonal treated prostate cancer. Eur Urol 2002; 41: 167-71.
[6] Verhagen P C, Hermans K G, Brok M O, et al. Deletion of chromosomal region 6q14-16 in prostate cancer. Int J Cancer 2002; 102: 142-7.
[7] Brothman A R. Cytogenetics and molecular genetics of cancer of the prostate. Am J Med Genet 2002; 115: 150-6.
[8] Matsuyama H, Pan Y, Oba K, et al. The role of chromosome 8p22 deletion for predicting disease progression and pathological staging in prostate cancer. Aktuelle Urol 2003; 34: 247-9.
[9] Bergerheim U S, Kunimi K, Collins V P, et al. Deletion mapping of chromosomes 8, 10, and 16 inhuman prostatic carcinoma. Genes Chromosomes Cancer 1991; 3: 215-20.
[10] Dong J T, Boyd J C, Frierson H F, Jr. Loss of heterozygosity at 13q14 and 13q21 in high grade, high stage prostate cancer. Prostate 2001; 49: 166-71.
[11] Matsuyama H, Pan Y, Yoshihiro S, et al. Clinical significance of chromosome 8p, 10q, and 16q deletions in prostate cancer. Prostate 2003; 54: 103-11.
[12] Brothman A R, Peehl D M, Patel A M, et al. Frequency and pattern of karyotypic abnormalities in human prostate cancer. Cancer Res 1990; 50: 3795-803.
[13] Kallioniemi A, Kallioniemi O P, Sudar D, et al. Comparative genomic hybridization for molecular cytogenetic analysis of solid tumors. Science 1992; 258: 818-21.
[14] Pinkel D, Segraves R, Sudar D, et al. High resolution analysis of DNA copy number variation using comparative genomic hybridization to microarrays. Nat Genet 1998; 20: 207-11.
[15] Mantripragada K K, Buckley P G, Diaz de Stahl T, et al. Genomic microarrays in the spotlight. Trends Genet 2004; 20: 87-94.
[16] Van Dekken H, Paris P L, Albertson D G, et al. Evaluation of genetic patterns in different tumor areas of intermediate-grade prostatic adenocarcinomas by high-resolution genomic array analysis. Genes Chromosomes Cancer 2004; 39: 249-56.
[17] Paris P L, Albertson D G, Alers J C, et al. High-resolution analysis of paraffin-embedded and formalin-fixed prostate tumors using comparative genomic hybridization to genomic microarrays. Am J Pathol 2003; 162: 763-70.
[18] Jones E, Zhu X L, Rohr L R, et al. Aneusomy of chromosomes 7 and 17 detected by FISH in prostate cancer and the effects of selection in vitro. Genes Chromosomes Cancer 1994; 11: 163-70.
[19] Deubler D A, Williams B J, Zhu X L, et al. Allelic loss detected on chromosomes 8, 10, and 17 by fluorescence in situ hybridization using single-copy P1 probes on isolated nuclei from paraffin-embedded prostate tumors [see comments]. Am J Pathol 1997; 150: 841-50.
[20] Williams B J, Jones E, Zhu X L, et al. Evidence for a tumor suppressor gene distal to BRCA1 in prostate cancer [see comments]. J Urol 1996; 155: 720-5.
[21] Amaratunga D C, J. Exploration and Analysis of DNA Microarray and Protein Array Data John Wiley and Sons, 2004.
[22] Husing J, Zeschnigk M, Boes T, et al. Combining DNA expression with positional information to detect functional silencing of chromosomal regions. Bioinformatics 2003; 19: 2335-42.
[23] Wilkinson L. SYSTAT 10, Statistics I. Chicago, Ill.: SPSS Inc., 2000.
[24] Clark J, Edwards S, Feber A, et al. Genome-wide screening for complete genetic loss in prostate cancer by comparative hybridization onto cDNA microarrays. Oncogene 2003; 22: 1247-52.
[25] Struski S, Doco-Fenzy M, Cornillet-Lefebvre P. Compilation of published comparative genomic hybridization studies. Cancer Genet Cytogenet 2002; 135: 63-90.
[26] Kasahara K, Taguchi T, Yamasaki I, et al. Detection of genetic alterations in advanced prostate cancer by comparative genomic hybridization. Cancer Genet Cytogenet 2002; 137: 59-63.
[27] Takahashi S, Alcaraz A, Brown J A, et al. Aneusomies of chromosomes 8 and Y detected by fluorescence in situ hybridization are prognostic markers for pathological stage C (pt3N0M0) prostate carcinoma [In Process Citation]. Clin Cancer Res 1996; 2: 137-45.
[28] Tsuchiya N, Kondo Y, Takahashi A, et al. Mapping and gene expression profile of the minimally overrepresented 8q24 region in prostate cancer. Am J Pathol 2002; 160: 1799-806.
[29] Reiter R E, Gu Z, Watabe T, et al. Prostate stem cell antigen: a cell surface marker overexpressed in prostate cancer. Proc Natl Acad Sci USA 1998; 95: 1735-40.
[30] Verhagen P C, Zhu X L, Rohr L R, et al. Microdissection, DOP-PCR, and comparative genomic hybridization of paraffin-embedded familial prostate cancers. Cancer Genet Cytogenet 2000; 122: 43-8.
[31] Pan Y, Matsuyama H, Wang N, et al. Chromosome 16q24 deletion and decreased E-cadherin expression: possible association with metastatic potential in prostate cancer. Prostate 1998; 36: 31-8.
[32] Dong J T, Chen C, Stultz B G, et al. Deletion at 13q21 is associated with aggressive prostate cancers. Cancer Res 2000; 60: 3880-3.
[33] Brooks J D, Bova G S, Isaacs W B. Allelic loss of the retinoblastoma gene in primary human prostatic adenocarcinomas. Prostate 1995; 26: 35-9.
[34] Melamed J, Einhorn J M, Ittmann M M. Allelic loss on chromosome 13q in human prostate carcinoma. Clin Cancer Res 1997; 3: 1867-72.
[35] Cooney K A, Wetzel J C, Merajver S D, et al. Distinct regions of allelic loss on 13q in prostate cancer. Cancer Res 1996; 56: 1142-5.
[36] Dai Q, Deubler D A, Maxwell T M, et al. A common deletion at chromosomal region 17q21 in sporadic prostate tumors distal to BRCA1. Genomics 2001; 71: 324-9.
[37] Atkin N B, Baker M C. Chromosome 10 deletion in carcinoma of the prostate [letter]. N Engl J Med 1985; 312: 315.
[38] Mitelman F, Mertens F, Johansson B. A breakpoint map of recurrent chromosomal rearrangements in human neoplasia. Nat Genet 1997; 15 Spec No: 417-74.

What is claimed is:

1. A method for utilizing identification of genomic aberrations as a predictive screening assay in diagnosis and/or prognosis of a disease, comprising:
determining, using genomic microarray-based comparative genomic hybridization (GM-CGH) of a plurality of tissue samples from a plurality of patients, respectively, the presence of at least one genomic aberration for at least one tissue sample from at least one patient; and,
identifying the at least one genomic aberration as having a correlation with a diagnostic and/or prognostic outcome.

2. A method of identifying genomic aberrations of predictive value in diagnosis and/or prognosis of a disease, comprising:
determining a presence of at least one genomic aberration for each of a plurality of whole tissue samples from patients with the disease, using genomic microarray-based comparative genomic hybridization (GM-CGH);
identifying a correlation between the at least one of said genomic aberration and a particular diagnostic and/or prognostic outcome, with a correlation efficiency (r) of greater than 0.7 or less than −0.7.

3. The method of claim 1 or 2, wherein said tissue sample has a high degree of complexity and/or rare cellular species.

4. The method of any of claims 1-3, wherein said tissue sample is not purified to separate a plurality of cell sub populations.

5. The method of any of claims 1-4, wherein the genomic DNA in said tissue sample is amplified prior to analysis by GM-CGH.

6. The method of claim 5, wherein said genomic DNA is amplified by a whole genome amplification selected from: whole genome PCR, Lone Linker PCR, Interspersed Repetitive Sequence PCR, Linker Adapter PCR, Priming Authorizing Random Mismatches-PCR, single cell comparative genomic hybridization (SCOMP), degenerate oligonucleotide-primed PCR (DOP-PCR), Sequence Independent PCR, Primer-extension pre-amplification (PEP), improved PEP (I-PEP), Tagged PCR (T-PCR), tagged random hexamer amplification (TRHA); or using rolling circle amplification (RCA), multiple displacement amplification (MDA), or multiple strand displacement amplification (MSDA).

7. The method of any of claims 1-6, wherein said GM-CGH is label-reversal (label-swapping) GM-CGH.

8. The method of any of claims 1-7, wherein said genomic aberration comprises one or more of: deletion, duplication or multiplication, chromosomal translocation or rearrangement, and a manifestation as trisomy, heterodiploidy, chromosomal gain, chromosomal deletion, and aneusomy.

9. The method of any of claims 1-8, wherein said disease is cancer.

10. The method of claim 9, wherein said cancer is a solid tumor.

11. The method of claim 10, wherein said solid tumor is selected from a tumor of the lung, prostate, breast, ovary, esophagus, head and neck, brain, colorectal, gastric, skin, liver, kidney, pancreas, mouth, and tongue.

12. The method of claim 9, wherein said cancer is a leukemia or a lymphoma.

13. The method of claim 9, wherein said cancer is prostate cancer.

14. The method according to any of claims 9-13, wherein said cancer is acute.

15. The method according to any of claims 9-13, wherein said cancer is chronic.

16. The method according to any of claims 1-8, wherein said disease is a chromosomal imbalance/aberration disease, such as Patau Syndrome, Edwards Syndrome, Down's Syndrome, Turner's Syndrome, Klinefelter Syndrome, William's Syndrome, Langer-Giedon Syndrome, Prader-Willi, Angelman's Syndrome, Rubenstein-Taybi and DiGeorge's Syndrome, Double Y syndrome, Trisomy X syndrome, Four X syndrome, Duchenne's/Becker syndrome, congenital adrenal hypoplasia, chronic granulomatus disease, steroid sulfatase deficiency, X-linked lymphproliferative disease, 1p-(somatic) neuroblastoma, monosomy trisomy, monosomy trisomy 2q associated growth retardation, developmental and mental delay, and minor physical abnormalities, non-Hodgkin's lymphoma, Acute non lymphocytic leukemia (ANLL), Cri du chat; Lejeune syndrome, myelodysplastic syndrome, clear-cell sarcoma, monosomy 7 syndrome of childhood; renal cortical adenomas; myelodysplastic syndrome, myelodysplastic syndrome; Warkany syndrome; chronic myelogenous leukemia, Alfi's syndrome, Rethore syndrome, complete trisomy 9 syndrome; mosaic trisomy 9 syndrome, ALL or ANLL, Aniridia; Wilms tumor, Jacobson Syndrome, myeloid lineages affected (ANLL, MDS), CLL, Juvenile granulosa cell tumor (JGCT), 13q-syndrome; Orbeli syndrome, retinoblastoma, myeloid disorders (MDS, ANLL, atypical CML), myeloid and lymphoid lineages affected (e.g., MDS, ANLL, ALL, CLL), papillary renal cell carcinomas (malignant), 17p syndrome in myeloid malignancies, Smith-Magenis, Miller-Dieker, renal cortical adenomas, Charcot-Marie Tooth Syndrome type 1; HNPP, 18p partial monosomy syndrome or Grouchy Lamy Thieffry syndrome, Grouchy Lamy Salmon Landry Syndrome, trisomy 20p syndrome, Alagille, MDS, ANLL, polycythemia vera, chronic neutrophilic leukemia, papillary renal cell carcinomas (malignant), velocardiofacial syndrome, conotruncal anomaly face syndrome, autosomal dominant Opitz G/BBB syndrome, Caylor cardiofacial syndrome, and complete trisomy 22 syndrome.

17. The method of any of claims 1-16, wherein said genomic aberration comprises a deletion located in the long arm of chromosome 2.

18. The method of any of claims 1-17, wherein said genomic aberration consists of at least one deletion selected from the group consisting of: 2q14-24, 2q31-32, 5q12.1-31, 8p22, 10q25, 13q14-21, 16q24 and Xq12-22.

19. The method of any of claims 1-17, wherein said genomic aberration comprises at least one deletion of 2q14-24, 2q31-32, 5q12.1-31, 8p22, 10q25, 13q14-21, 16q24, and Xq12-22.

20. The method of claim 18 or 19, wherein the disease is prostate cancer.

21. The method of any of claims 1-20, wherein at least two of said samples are obtained from different tissues.

22. The method of any of claims 1-21, wherein said sample is a freshly obtained tissue.

23. The method of any of claims 1-21, wherein said sample is a stored sample.

24. The method of any of claims 1-23, wherein said prognosis is survival over a fixed length of time after diagnosis, or responsiveness to a specific treatment.

25. The method of claim 24, wherein said specific treatment is at least one selected from: hormone therapy, surgical intervention, radiotherapy, and chemotherapy.

26. The method of claim 1, wherein the disease is prostate cancer, and wherein the DNA in the microarray comprises normal human chromosomal DNA corresponding to a plurality of genomic aberrations selected from the group of deletions consisting of: 2q14-24, 2q31-32, 5q12.1-31, 8p22, 10q25, 13q14-21, 13q14-21, 16q24, and Xq12-22.

27. The method of any of claims 1-26, wherein said GM-CGH is performed with a genomic microarray comprising probes corresponding to all or part of the chromosomal regions identified in FIG. 3 as Prominent Minimal Region of Interest (PMRI).

28. The method of any of claims 1-27, wherein said GM-CGH is performed with a genomic microarray comprising probes corresponding to 8p and 13q chromosomal regions of said PMRI.

29. The method of any of claims 1-28, wherein said genomic microarray has a resolution of about 0.3 mega-base (Mb), 0.5 Mb, 0.8 Mb, 1 Mb, 2 Mb, or about 3 Mb.

30. A method for diagnosis and/or prognosis of a prostate cancer, comprising:
determining, by genomic microarray-based comparative genomic hybridization (GM-CGH), in a prostate tissue sample from a patient, the presence of one or more genomic aberrations as shown in Table 2.

31. The method of claim 30, wherein the tissue sample is obtained without isolation of tumor cell sub populations.

32. The method of claim 30 or 31, which is performed with a genomic microarray comprising probes corresponding to all or part of the chromosomal regions identified in FIG. 3 as Prominent Minimal Region of Interest (PMRI).

33. The method of any of claims 30-32, wherein detection of a loss at 5q12.1-31 or 2q indicates a positive node status.

34. A subset of genomic DNA fragments, each encompassing at least one of the genomic aberrations of diagnosis and/or prognosis value for a disease as identified according to any of the above claims.

35. The subset of genomic DNA fragments of claim 34, comprising the chromosomal regions identified in FIG. 3 as Prominent Minimal Region of Interest (PMRI).

36. The subset of genomic DNA fragments of claim 34 or 35, the average size of which is about 0.3 mega-base (Mb), 0.5 Mb, 0.8 Mb, 1 Mb, 2 Mb, or about 3 Mb.

37. A library of nucleic acids for detecting the genomic aberrations listed in Table 2 or the Prominent Minimal Region of Interest (PMRI) in FIG. 3.

38. A genomic microarray for detecting genomic aberrations by GM-CGH, comprising nucleic acids for detecting at least one aberration listed in Table 2 or the Prominent Minimal Region of Interest (PMRI) in FIG. 3.

39. A genomic microarray for detecting prostate cancer by GM-CGH of a tissue sample, comprising nucleic acid probes for detecting at least one aberration of chromosomes corresponding to locations 5q12.1-31 or 2q.

40. The genomic microarray of claim 38, comprising nucleic acids for detecting a plurality of aberrations listed in Table 2 or the Prominent Minimal Region of Interest (PMRI) in FIG. 3.

41. The genomic microarray of claim 40, comprising nucleic acids for detecting at least 10 aberrations listed in Table 2 or the Prominent Minimal Region of Interest (PMRI) in FIG. 3.

42. The genomic microarray of any of claims 38-41, wherein the average size of said nucleic acids is about 0.3 mega-base (Mb), 0.5 Mb, 0.8 Mb, 1 Mb, 2 Mb, or about 3 Mb.

43. A medium embodying a database of disease tissues with a plurality of entries, comprising data selected from: two or more of each of tissue source, tissue type, patient information, GM-CGH-identified genomic aberration(s) in said disease tissues, associated with at least one of specific clinical outcome(s), and cytological corroboration data of said genomic aberration.

44. The medium of claim 43, wherein the disease tissues are prostate tissues.

45. The medium of claim 43, wherein the genomic aberration(s) is a deletion of the long arm of chromosome 2.

46. The medium of any of claims 43-45, wherein the specific clinical outcome(s) further comprises data from at least one of: surveillance of patients in remission; treatment monitoring for desired effect; treatment selection with respect to efficacy and safety; prognosis and staging of the tumor; differential diagnosis of metastasis; screening of tissues remote to site of initial tumor; and risk assessment for future cancer development.

47. A medium comprising a computer program for selecting and analyzing data from a genomic microarray-based comparative genomic hybridization (GM-CGH) of a genome or a subset of a genome, wherein selecting the data comprises analyzing chromosomal loci corresponding to a specific disease.

48. The medium of claim 47, wherein the disease is cancer.

49. The medium of claim 47, wherein the disease is prostate cancer.

50. The medium of claim 47, wherein selecting data comprises identifying/collecting hybridization to probes corresponding to chromosomal regions selected from at least one of: 2q14-24, 2q31-32, 5q12.1-31, 8p22, 10q25, 13q14-21, 16q24, and Xq12-22.

51. The medium of claim 47, wherein selecting data comprises identifying/collecting hybridization to probes corresponding to chromosomal regions selected from at least one of: 2q14-24, 2q31-32, and 8p22.

52. In a method of genomic microarray-based comparative genomic hybridization (GM-CGH) of a genome, the improvement comprising selecting data corresponding to one or more loci associated with a specific disease using a computer program, and diagnosing or prognosing the disease.


SEQUENCE LISTING (10 sequences)

SEQ ID NO: 1 - DNA, 20 bp, Artificial Sequence
  PCR oligomer for whole genome amplification
gagtagaattctaatatcta

SEQ ID NO: 2 - DNA, 20 bp, Artificial Sequence
  PCR oligomer for whole genome amplification
gagatattagaattctactc

SEQ ID NO: 3 - DNA, 21 bp, Artificial Sequence
  oligomer for Ligation-mediated PCR
agtgggattccgcatgctagt

SEQ ID NO: 4 - DNA, 12 bp, Artificial Sequence
  oligomer for Ligation-mediated PCR
taactagcatgc

SEQ ID NO: 5 - DNA, 20 bp, Artificial Sequence
  oligomer for degenerate oligonucleotide-primed PCR
ttgcggccgcattnnnnttc

SEQ ID NO: 6 - DNA, 22 bp, Artificial Sequence
  oligomer for degenerate oligonucleotide-primed PCR
ccgactcgacnnnnnnatgtgg

SEQ ID NO: 7 - DNA, 21 bp, Artificial Sequence
  oligomer for sequence-independent PCR
tggtagctcttgatcannnnn

SEQ ID NO: 8 - DNA, 20 bp, Artificial Sequence
  oligomer for sequence-independent PCR
agagttggtagctcttgatc

SEQ ID NO: 9 - DNA, 28 bp, Artificial Sequence
  oligomer for tagged random hexamer amplification
gtaatacgactcactatagggcnnnnnn

SEQ ID NO: 10 - DNA, 22 bp, Artificial Sequence
  oligomer for tagged random hexamer amplification
gtaatacgactcactatagggc